(19) United States
(12) Patent Application Publication
(10) Pub. No.: US 2002/0138396 A1
(43) Pub. Date: Sep. 26, 2002

(54) Methods and apparatus for exchanging ferrous, non-ferrous and platinum group metals

(76) Inventors: A. Demetrius Brown, Highland Park, IL (US); Sanford L. Beard, Wheaton, IL (US); Winifried B. Brown, Highland Park, IL (US); Antonio Caravia, West Bloomfield, MI (US)

Correspondence Address: MARSHALL, GERSTEIN & BORUN, 6300 SEARS TOWER, 233 SOUTH WACKER, CHICAGO, IL, 60606-6357, US

(21) Appl. No.: 09/814,014

(22) Filed: Mar. 21, 2001

(51) Int. Cl. G06F 17/60

(52) U.S. Cl. 705/37

(57) ABSTRACT

Methods and apparatus for facilitating an exchange of ferrous, non-ferrous and platinum group metals via an electronic network are disclosed. In operation, an authorized metal seller uploads information about one or more physical lots of metal and/or one or more derivative contracts to an exchange server. In addition, the metal seller may upload information about preexisting credit relationships he has established with certain metal buyers. Subsequently, an authorized metal buyer downloads the information. Although the metal seller's identity is preferably unknown to the metal buyer, an icon is placed next to each metal lot which belongs to a metal seller who has a preexisting credit relationship with the metal buyer. In addition, the metal buyer may access other information and services such as price indices, hedging, and financing, from within the same web site or from a separate web site. If the metal buyer purchases a metal lot and/or a derivative contract, the appropriate accounts are updated and the parties are informed. In addition, the buyer and/or the seller may receive updated portfolio valuations and/or mark to market analysis. Importantly, the process provides complete price transparency for ferrous, non-ferrous and platinum group metals and allows for the exchange of metals derivative contracts which are cash settled and fully compliant with FAS133. The end result for users of the system is the ability to negotiate and lock in a fixed price for a forward delivery of a specific metal alloy through a single online location. As a result, volatility of profit margins is reduced.

### TECHNICAL FIELD

The present invention relates in general to online exchanges and, in particular, to methods and apparatus for facilitating an exchange of ferrous, non-ferrous and platinum group metals via an electronic network.

### BACKGROUND

Many products, especially automobiles, require a significant amount of raw metal for their production. For example, a significant amount of aluminum is used in automobile components, and platinum group metals are essential for catalytic converters. However, most manufactures do not want these metals in their pure form. For example, pure aluminum is rarely used in an automobile, but several different aluminum alloys are very common in automobiles. Often, to acquire the metal they require, product manufacturers must regularly contact a plurality of metal producers and establish contracts for metal delivery. In addition, a few private metal exchanges and metal arbitrage operations are used to acquire metals.

However, all three of these current methods of acquiring metals suffer from certain drawbacks. Regularly contacting a plurality of metal producers can be cumbersome and time consuming. In addition, sales made in this manner are private. As a result, there is no price transparency (i.e., nobody knows what everybody else is paying for the same metals). Although some industry publications conduct daily surveys of the major metal producers, the results are insufficient to establish a true index for several reasons. First, the results rely on accurate responses from the metal producers who are motivated to keep prices high. Second, the results are typically based on each metal producer's most recent sale, not all of the sales that day. Third, the results are not weighted based on the amount of metal moved at each price point. Furthermore, without accurate pricing information, metal industry participants are at a disadvantage. Without a true index for the metals they are actually using (e.g., a particular aluminum alloy as opposed to pure aluminum), product manufacturers and producers are unable to trade derivative contracts which meet the requirements of the Statement of Financial Accounting Standards No. 133 (FAS133).

Private metal exchanges, such as the London Metal Exchange, suffer from similar transparency problems, and do not adequately match their financial products with the actual metal delivered and consumed. In addition, these exchanges are typically established for the benefit of a small number of private members. Similarly, metal arbitrage operations, such as Goldman Sachs, suffer from the same transparency problems. In fact, arbitrage operations rely on a lack of price transparency in order to pocket the difference between the price the seller has in mind and the price the buyer has in mind. As a result, metal sellers are selling at prices below the market value and metal buyers are buying at prices above the market value.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a network communications system employing an embodiment of the present invention.

FIG. 2 is a more detailed block diagram of one of the client devices illustrated in FIG. 1.

FIG. 3 is a more detailed block diagram showing one embodiment of the metals exchange server illustrated in FIG. 1.

FIG. 4 is a more detailed block diagram showing another embodiment of the metals exchange server illustrated in FIG. 1.

FIG. 5 is a high level flowchart of business method for exchanging ferrous, non-ferrous and platinum group metals online which provides both physical and financial services.

FIG. 6 is a more detailed flowchart of certain physical services illustrated in FIG. 5.

FIG. 7 is a screen-shot of an exemplary main logistics web page.

FIG. 8 is a screen-shot of an exemplary logistics web page showing details of a particular metal lot.

FIG. 9 is a screen-shot of an exemplary logistics web page used to request a shipping quotation.

FIG. 10 is a screen-shot of an exemplary logistics web page used to display a shipping quotation.

FIGS. 11A-11B are screen-shots of an exemplary logistics web page used to enter detailed shipping information.

FIGS. 12A-12B are a more detailed flowchart of a process for exchanging ferrous, non-ferrous and platinum group metals online.

FIG. 13 is a screen-shot of an exemplary web page used for logging into a metals exchange system.

FIG. 14 is a screen-shot of an exemplary web page showing the main physical trading floor of an online metals exchange.

FIG. 15 is a screen-shot of an exemplary web page showing the hedge trading floor of an online metals exchange.

FIG. 16 is a screen-shot of an exemplary web page showing price index information.

FIG. 17 is a screen-shot of an exemplary web page showing a credit relationship form.

FIGS. 18-20 are screen-shots of exemplary web pages used for posting a metal lot to the exchange server.

FIG. 21 is a screen-shot of an exemplary web page showing a form for identifying the chemistry of a metal lot to be posted.

FIG. 22 is a screen-shot of an exemplary web page showing a chemistry value matrix.

FIG. 23 is a screen-shot of an exemplary web page showing posted contracts with credit relationship icons.

FIG. 24 is a screen-shot of an exemplary web page showing metal identification information.

FIGS. 25-29 are screen-shots of exemplary web pages used to submit a bid to the exchange server.

FIG. 30 is a screen-shot of an exemplary web page used to accept a bid.

FIG. 31 is a screen-shot of an exemplary web page showing Brady Trinity spot prices.

FIG. 32 is a screen-shot of an exemplary web page showing a Brady Trinity revaluation.

FIG. 33 is a screen-shot of an exemplary mark to market introduction web page.

FIG. 34 is a screen-shot of an exemplary mark to market physical purchase entry web page.

FIG. 35 is a screen-shot of an exemplary mark to market web page showing a list of physical purchases.

FIG. 36 is a screen-shot of an exemplary mark to market web page showing a list of financial transactions.

FIG. 37 is a screen-shot of an exemplary mark to market web page used for price sensitivity data entry.

FIG. 38 is a screen-shot of an exemplary mark to market sensitivity analysis web page.

FIG. 39 is a screen-shot of an exemplary web page showing a mark to market chart.

FIG. 40 is a screen-shot of an exemplary web page showing a combined volume exposure chart.

### DETAILED DESCRIPTION OF EXEMPLARY EMBODIMENTS

In general, the system described herein allows a user to exchange ferrous, non-ferrous and platinum group metals via an electronic network such as the Internet. In operation, an authorized metal seller uploads information about one or more physical lots of metal and/or one or more derivative contracts to an exchange server. In addition, the metal seller may upload information about preexisting credit relationships he has established with certain metal buyers.

Subsequently, an authorized metal buyer downloads the information. Although the metal seller's identity is preferably unknown to the metal buyer, an icon is placed next to each metal lot which belongs to a metal seller who has a preexisting credit relationship with the metal buyer. In addition, the metal buyer may access other information and services such as price indices, hedging, and financing, from within the same web site or from a separate web site. If the metal buyer purchases a metal lot and/or a derivative contract, the appropriate accounts are updated and the parties are informed.

In addition, the buyer and/or the seller may receive updated portfolio valuations and/or mark to market analysis. Importantly, the process provides complete price transparency for ferrous, non-ferrous and platinum group metals and allows for the exchange of metals derivative contracts which are cash settled and fully compliant with FAS133. The end result for users of the system is the ability to negotiate and lock in a fixed price for a forward delivery of a specific metal alloy through a single online location. As a result, volatility of profit margins is reduced.

FAS133 requires all derivatives to be carried on the balance sheet at a fair market value. In addition, FAS133 requires all changes in fair market value be recognized in the income statement unless certain requirements are met. As a result, the financial statement may experience a certain volatility. However, the potential volatility may be reduced by special hedge accounting rules. If a derivative qualifies as a hedge, “hedge accounting” may be used to reduce the income statement volatility that would occur if the company reported changes in the derivative's fair value as income. The type of accounting that must be used depends on the kind of exposure being hedged (cash flow or fair value) and on the effectiveness of the hedge. FAS133 requires extensive disclosure for hedge accounting.

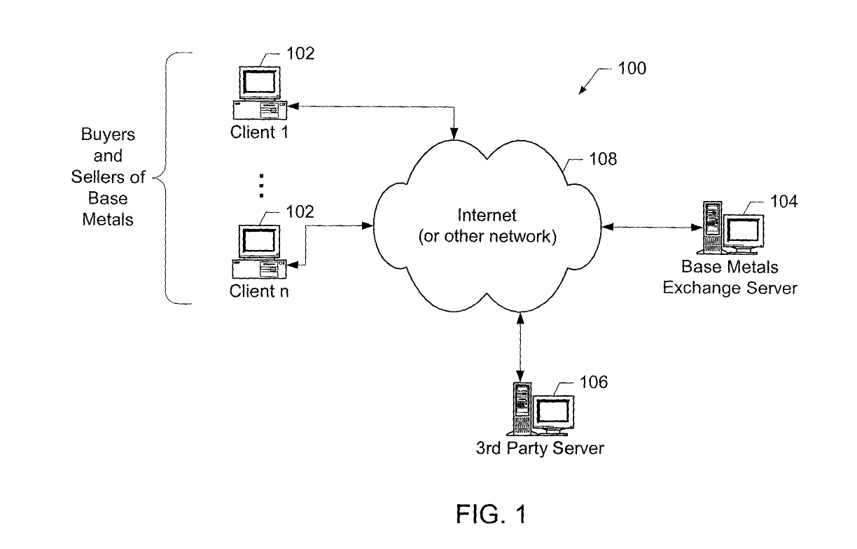

Turning to the figures, a high level block diagram of an exemplary network communications system 100 capable of employing the teachings of the present invention is illustrated in FIG. 1. Typically, the system 100 includes one or more client devices 102, one or more metal exchange servers 104, and one or more third party servers 106. Each of these devices may communicate with each other via a connection to the Internet or some other wide area network 108.

Typically, metal exchange servers 104 store a plurality of files, programs, and/or web pages for use by the client devices 102 and/or the third party servers 106. One metal exchange server 104 may handle requests from a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

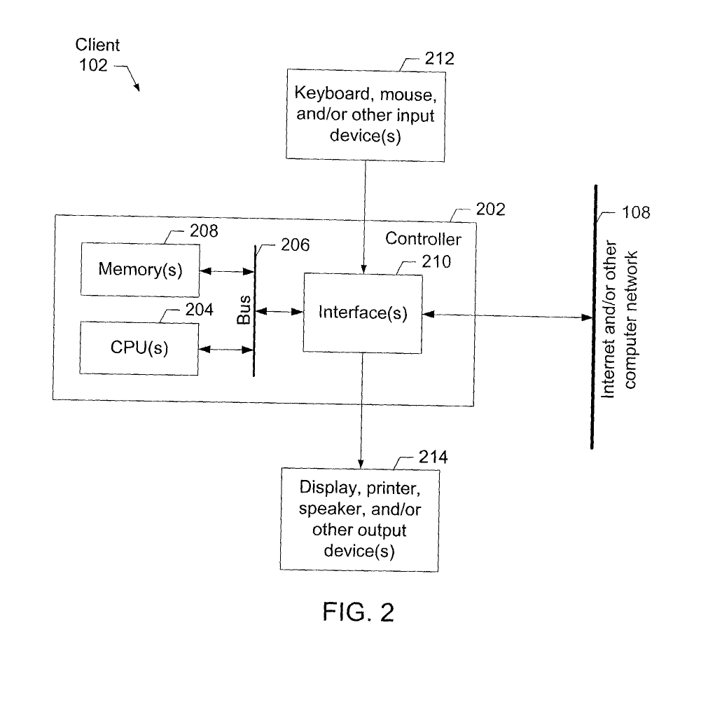

A more detailed block diagram of a client device 102 is illustrated in FIG. 2. The client device may be a personal computer (PC), a personal digital assistant (PDA), an Internet appliance, a cellular telephone, or any other communication device. The client 102 includes a controller 202 which preferably includes a central processing unit 204 electrically coupled by an address/data bus 206 to a memory device 208 and an interface circuit 210. The CPU 204 may be any type of well known CPU, such as an Intel Pentium™ processor. The memory device 208 preferably includes volatile memory and non-volatile memory. Preferably, the memory device 208 stores a software program that interacts with the metal exchange server 104 as described below. This program may be executed by the CPU 204 in a well known manner. The memory device 208 may also store digital data indicative of documents, files, programs, web pages, etc. retrieved from a server 104, 106 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, speakers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the metal exchange server 104. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, etc. Users of the system 100 may be required to register with the metal exchange server 104. In such an instance, each user may choose a username and a password which may be required for the activation of services. The username and password may be passed across the Internet 108 using encryption built into the user's browser. Alternatively, the username and/or password may be assigned by the metal exchange server 104.

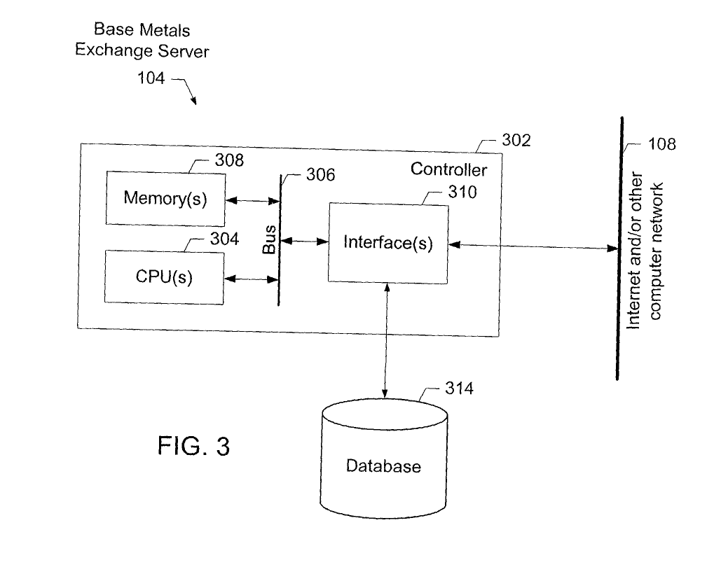

A more detailed block diagram of a metal exchange server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel Pentium™ processor, and the memory device 308 preferably includes volatile memory and non-volatile memory. Preferably, the memory device 308 stores a software program that implements all or part of the method described below. This program may be executed by the CPU 304 in a well known manner. However, some of the steps described in the method below may be performed manually or without the use of the server 104. The memory device 308 and/or a separate database 314 also store files, programs, web pages, etc. for use by servers 104, 106 and/or the client devices 102.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

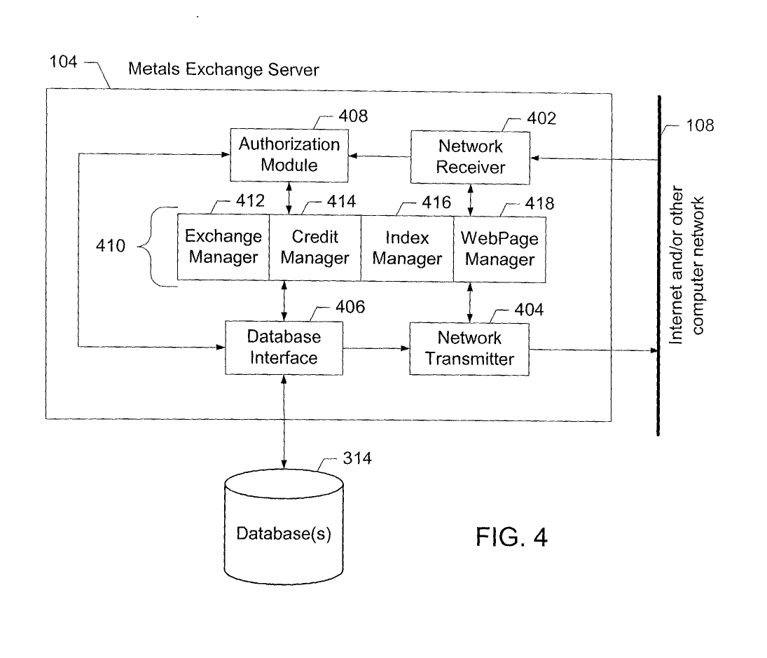

A more detailed block diagram of another embodiment of the metals exchange server 104 is illustrated in FIG. 4. In this embodiment, the metals exchange server 104 includes a plurality of interconnected modules 402-418. Each of the modules may be implemented by a microprocessor executing software instructions and/or conventional electronic circuitry. In addition, a person of ordinary skill in the art will readily appreciate that certain modules may be combined or divided according to customary design constraints.

For the purpose of receiving web page requests, purchase requests, usernames, passwords, metal identification information, metal types, metal weights, prices, credit relationship information, metal chemistry compositions, metal chemistry evaluation matrices, and other data, the metals exchange server 104 includes a network receiver 402. The network receiver 402 is operatively coupled to the network 108 in a well known manner. For example, the network receiver 402 may be an Ethernet interface circuit electrically coupled to the Internet via an Ethernet cable.

For the purpose of transmitting web pages, metal identification information, credit relationship icons, metal exchange transaction information, metal lot records, derivative contract information, portfolio valuations, mark to market determinations, payment guarantees, financing options, metal chemistry compositions, metal chemistry evaluation matrices, and other data, the metals exchange server 104 includes a network transmitter 404. The network transmitter 404 is operatively coupled to the network 108 in a well known manner. For example, the network transmitter 404 may also be an Ethernet interface circuit electrically coupled to the Internet via an Ethernet cable.

For the purpose of storing web page data, web page code, purchase requests, usernames, passwords, metal identification information, metal types, metal weights, prices, credit relationship information, metal chemistry compositions, metal chemistry evaluation matrices, credit relationship icons, metal exchange transaction information, metal lot records, derivative contract information, portfolio valuations, mark to market determinations, payment guarantees, financing options, and other data, the exchange server 104 includes a memory device 314. The memory device 314 may be a single memory device or a combination of memory devices. The memory device 314 may be volatile memory, non-volatile memory, or a combination of volatile and non-volatile memory. The memory device 314 may be a local memory device, a remote memory device, or a combination of local and remote memory devices.

For the purpose of sending data to and retrieving data from the database 314, the exchange server 104 includes a database interface 406. The database interface 406 is operatively coupled to the network receiver 402, the network transmitter 404, and the database 314. The database interface 406 manages the physical connection and the protocol connection to the database 314 in a well known manner.

For the purpose of providing security, the exchange server 104 includes an authorization module 408. The authorization module 408 is operatively coupled to the receiver 402 and the database interface 406. The authorization module 408 receives a user name and/or password from the receiver 402 and determines if the user name and/or password are associated with a registered user by querying the database 314 via the database interface 406.

For the purpose of controlling the overall operation of the exchange server 104 and managing individual operations within the exchange server 104, the exchange server 104 includes a management module 410. The management module 410 is operatively coupled to the receiver 402, the transmitter 404, the database interface 406, and the authorization module 408. The management module 410 preferably includes several sub-modules. Specifically, the management module 410 may include an exchange manager 412, a credit manager 414, an index manager 416, and a web page manager 418.

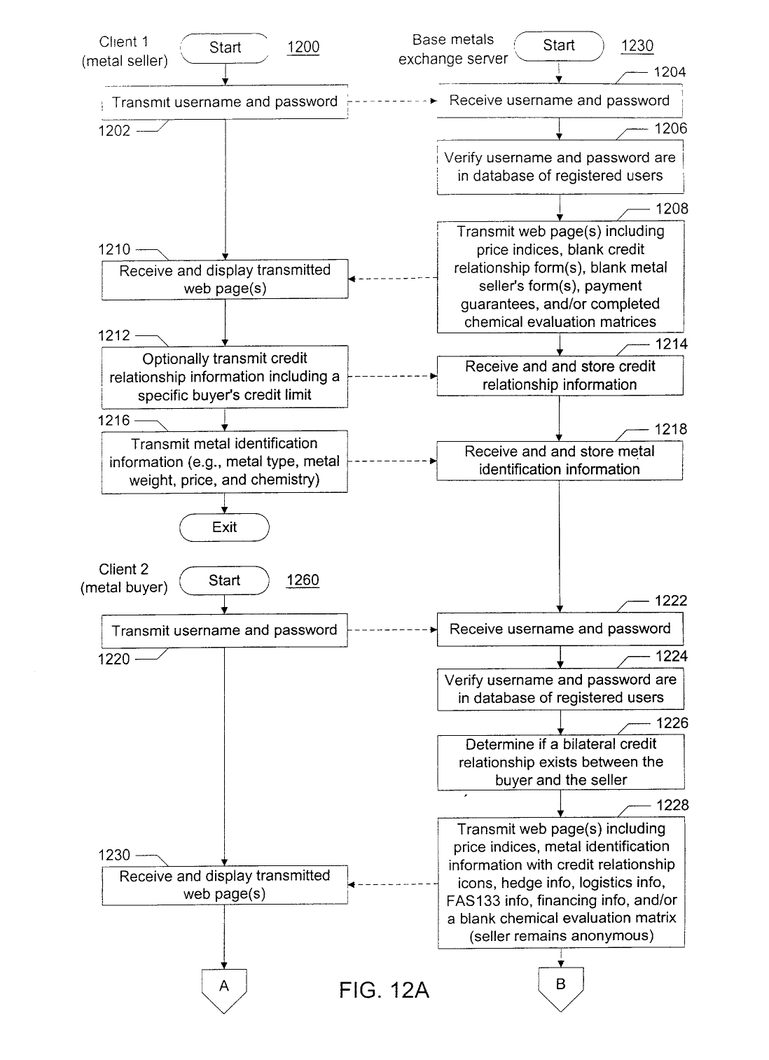

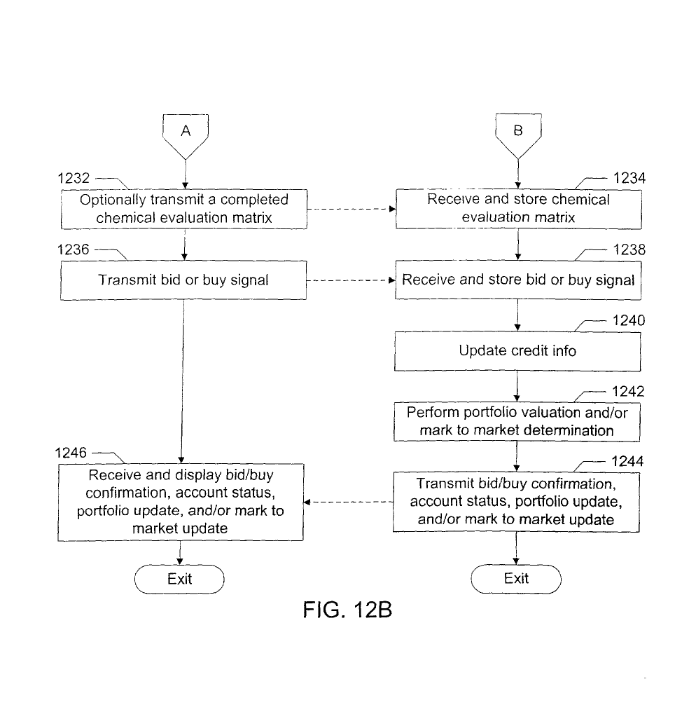

The exchange manager 412 manages the organization and display of metal identification information, metal chemistry compositions, metal chemistry evaluation matrices, metal exchange transaction information, metal lot records, derivative contract information, and any other metal exchange data. The operation of the exchange manager 412 is described in detail below with reference to FIG. 12.

The credit manager 414 determines if a preexisting bilateral credit relationship exists between a particular metal buyer and a particular metal seller. In addition, the credit manager 414 may maintain the current status of credit accounts between buyers and sellers and determine if a hypothetical purchase would exceed the current available credit limit. Further, the credit manager 414 may maintain an account for finance and/or payment guarantee operations. The operation of the credit manager 414 is described in detail below with reference to FIG. 12.

The index manager 416 maintains a plurality of indices for a plurality of different metals which are traded via the metal exchange server. Preferably, each price index is a weighted moving average associated with a specific type of metal based on all exchanges processed by the exchange server 104 over a given period of time. The operation of the credit manager 414 is described in detail below with reference to FIG. 12.

The web page manager 418 retrieves web pages and web page elements from the database and dynamically creates the web pages transmitted to the client device 102. For example, the web page manager 418 creates a metals exchange web page. Preferably, the metals exchange web page includes metal identification information (e.g., lot number, metal type, metal weight, metal composition, and price) and a positive icon if a preexisting credit relationship exists between the metal buyer and the metal seller. If a preexisting credit relationship does not exist between the metal buyer and the metal seller, a negative icon may be used. However, the metal seller is preferably not specifically identified in the metals exchange web page (i.e., the seller remains anonymous at least until the sale is transacted).

In addition, the web page manager 418 preferably manages one or more metals hedging web pages, logistics web pages, FAS133 compliant derivative contract web pages, portfolio valuation web pages, mark to market determination web pages, payment guarantee web pages, financing web pages, and transportational logistics web pages, all within the same metals exchange web site. In this manner, registered users can enjoy the convenience of these services in an integrated environment.

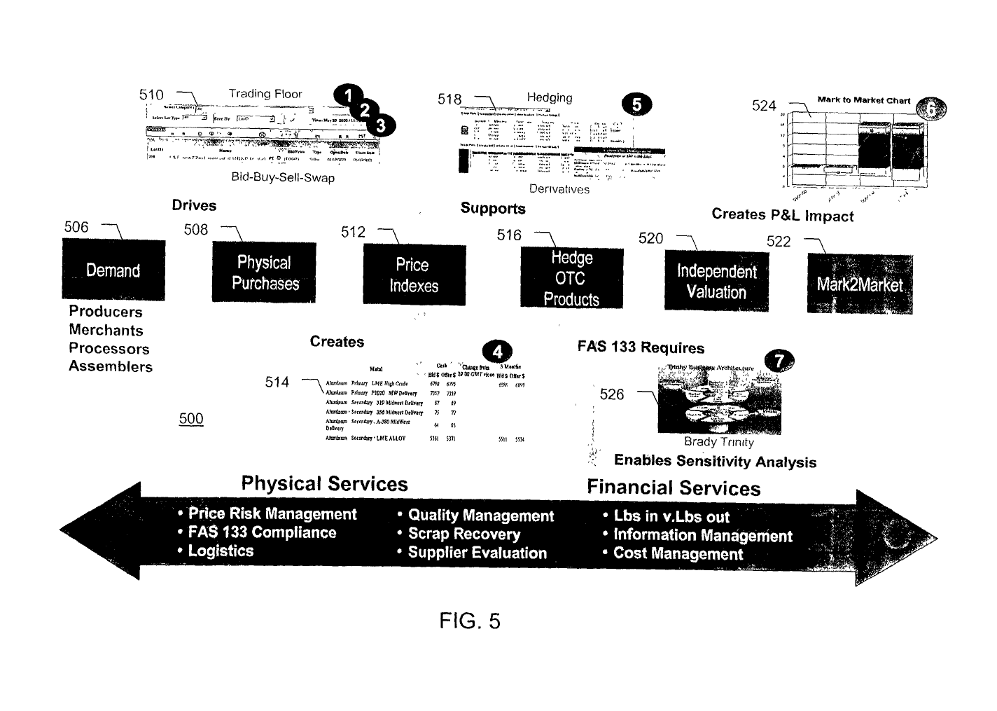

A high level flowchart of a business method 500 for exchanging metals online which provides both physical services and financial services is illustrated in FIG. 5. Initially, producers, merchants, processors, assemblers, and other metal consumers create a demand for various metals (step 506). These metals include ferrous, non-ferrous and platinum group metals. For example, most automobile manufactures require aluminum alloys and platinum group metals. This demand drives a plurality of physical metal purchases (step 508). Preferably, these purchases take place at an online trading floor 510 as described in detail below. Processing the plurality of physical metal purchases online allows the metals exchange server 104 to create price indices (step 512). Subsequently, a price index display 514 is transmitted to the users of the online system to provide complete price transparency. Because price indices are available, hedging and derivative products which meet FAS133 requirements are supported (step 516). These products are preferably bought and sold online via a forward purchasing web page 518. After each metal purchase, an independent valuation may be performed (step 520) and/or mark to market analysis may be performed (step 522). In this manner, profit/loss impacts 524 and sensitivity analysis 526 may be visualized.

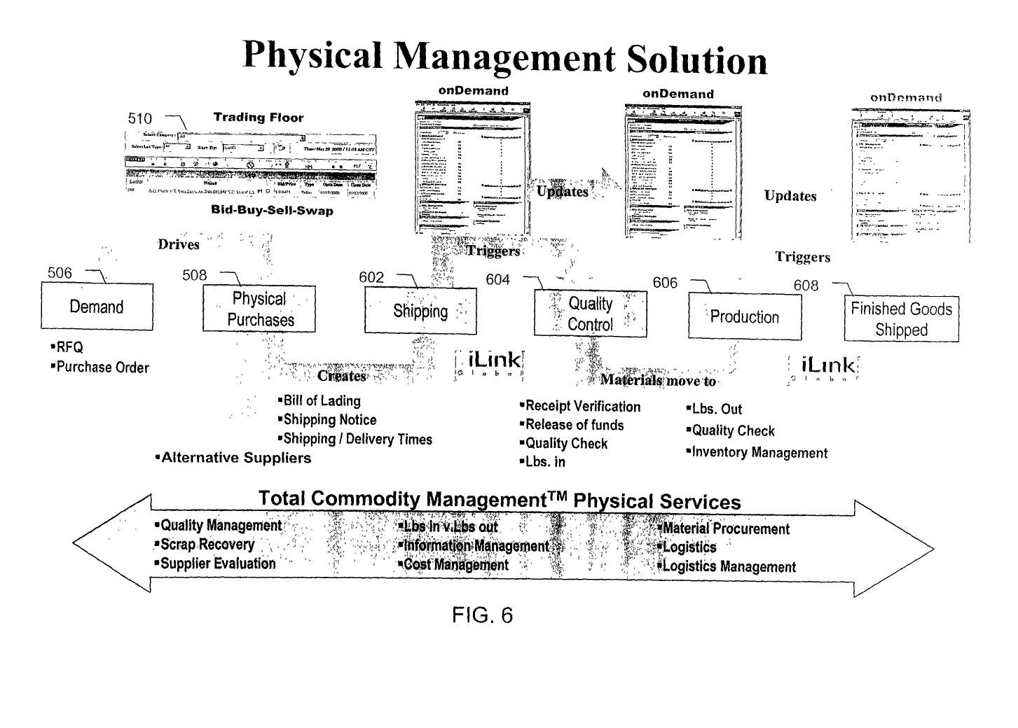

A more detailed flowchart of certain physical services described above is illustrated in FIG. 6. In addition to the steps described above, the physical services offered include transportational logistics services. Once a physical lot is purchased, the system may automatically create a bill of lading, a shipping notice, schedules, and other shipping information (step 602). This in turn triggers receipt verification, release of funds, quality checks, weigh-ins, and/or other quality control process (step 604). The materials then move to production (step 606) and shipping (step 608). In the preferred embodiment, iLink Global™ is used to provide these services online.

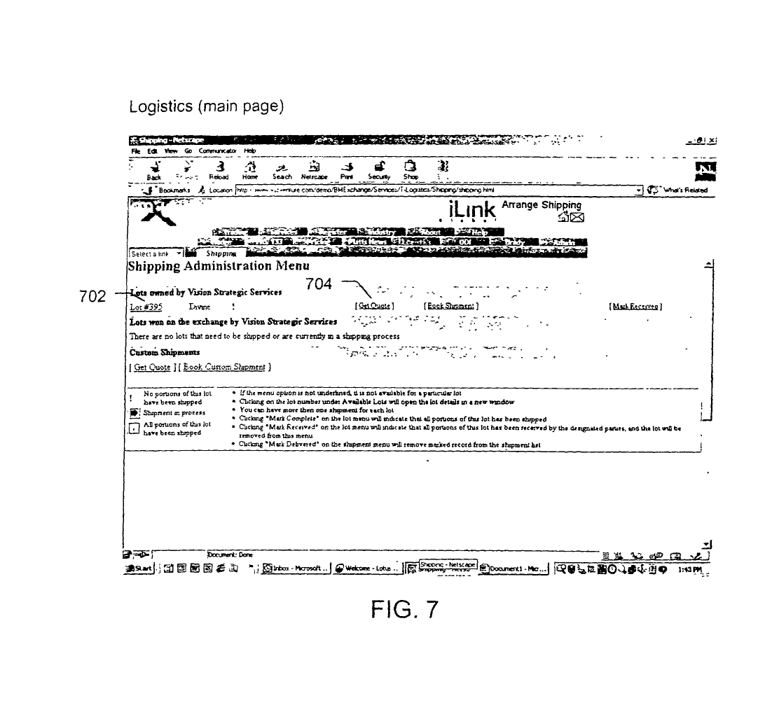

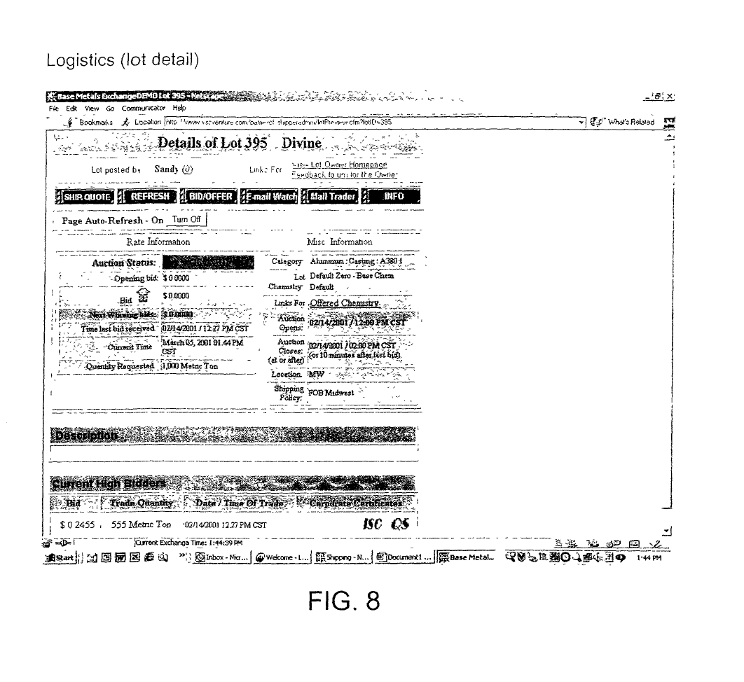

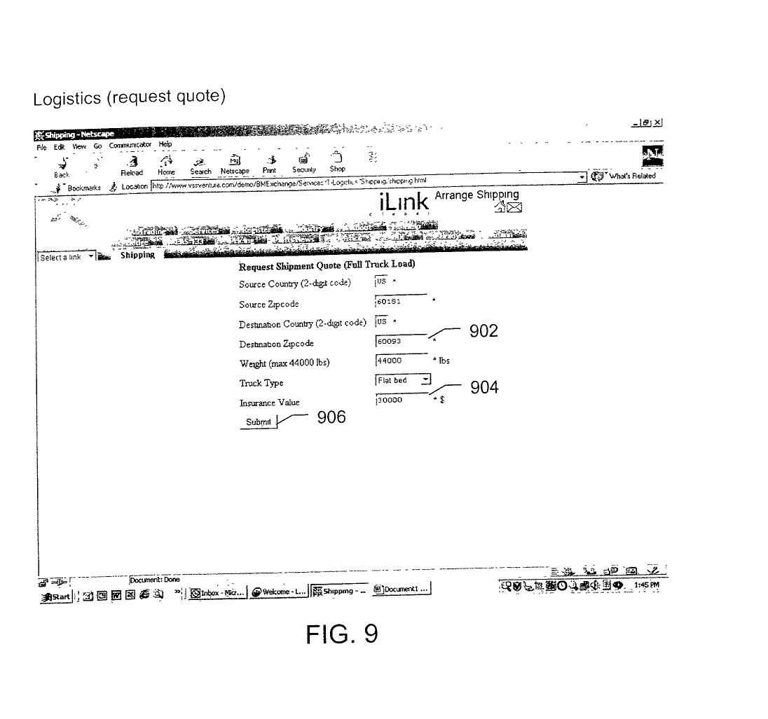

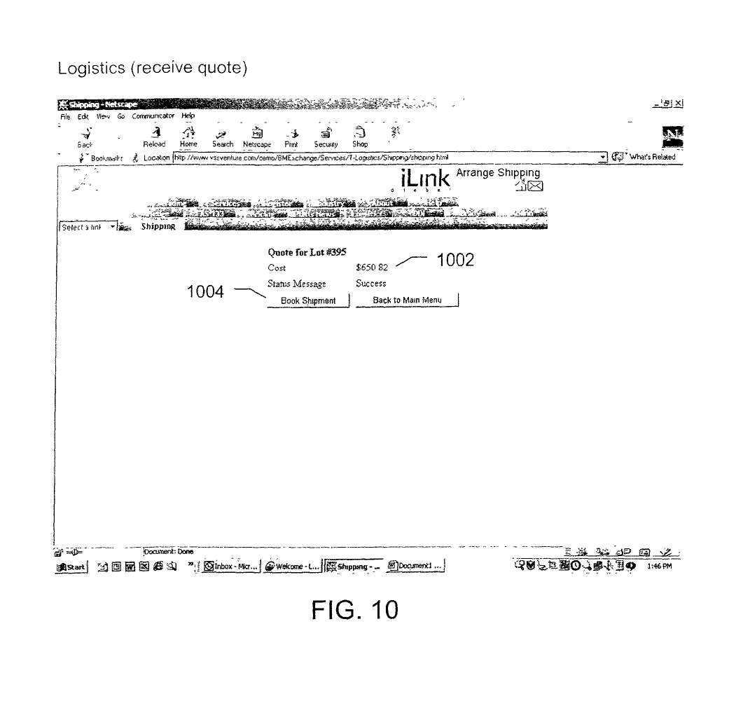

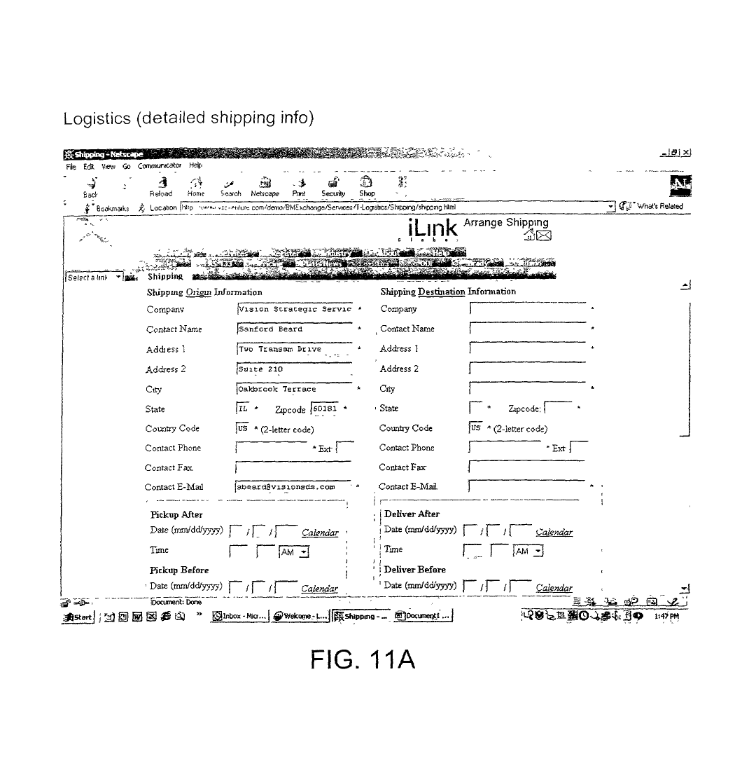

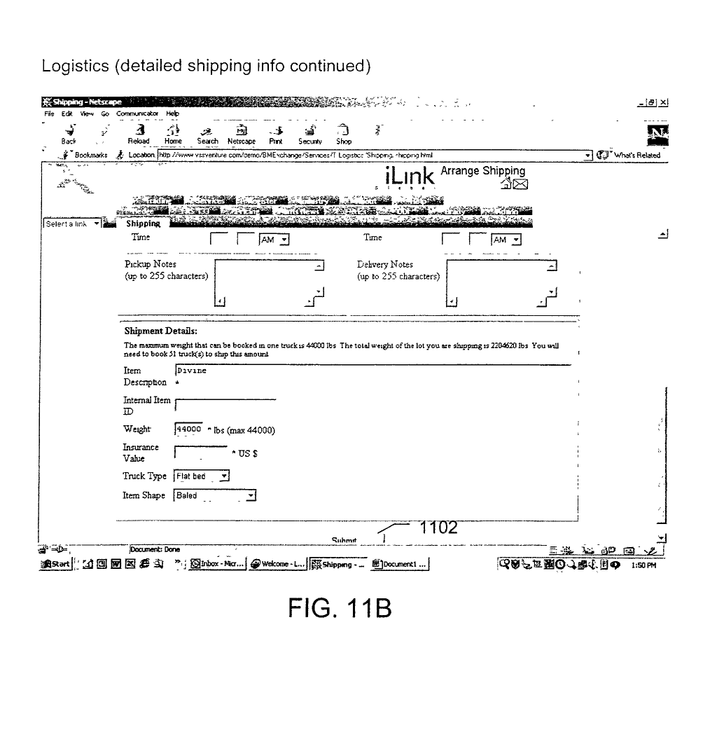

Screen-shots of exemplary web pages used for arranging logistic services are illustrated in FIGS. 7-11B. In this example, one lot was purchased from “Divine” and is ready for shipping (see FIG. 7 for main logistics screen). The user may select a lot hyperlink 702 on the main logistics screen to see the lot detail which is illustrated in FIG. 8. The user may select a “Get Quote” hyperlink 704 on the main logistics screen to receive a shipping quote. The user need only supply the destination zip code 902 and the insurance value 904. All the other information is supplied automatically by the lot information in the database 314 (see FIG. 9). After selecting a “Submit” hyperlink 906, the quote 1002 returns within a few seconds (see FIG. 10). If the user is satisfied with the quote, he may select the “Book Shipment” hyperlink 1002 to call up another web page (see FIGS. 11A-11B) where additional shipping information is entered. Once the shipping information is entered, the user selects another “Submit” hyperlink 1102 to initiate a sequence which will dispatch the trucks and provide online tracking.

A more detailed flowchart of a process for exchanging ferrous, non-ferrous and platinum group metals online is illustrated in FIGS. 12A-12B. Preferably, the process is embodied in three software programs 1200, 1230, 1260. The first software program 1200 is preferably stored in a first client memory 208 and executed by a first client CPU 204 in a well known manner. The second software program 1230 is preferably stored in the exchange server memory 308 and executed by the exchange server CPU 304 in a well known manner. The third software program 1260 is preferably stored in a second client memory 208 and executed by a second client CPU 204 in a well known manner. However, some or all of the steps of the programs 1200, 1230, 1260 may be performed manually and/or by another device. Although the programs 1200, 1230, 1260 are described with reference to the flowchart illustrated in FIGS. 12A-12B, a person of ordinary skill in the art will readily appreciate that many other methods of performing the acts associated with the programs 1200, 1230, 1260 may be used. For example, the order of many of the steps may be changed without departing from the scope or spirit of the present invention. In addition, many of the steps described are optional.

Generally, the client programs 1200, 1260 communicate with each other indirectly via the server program 1230. In operation, an authorized metal seller uploads information about one or more lots of metal he wishes to sell. Preferably, the metal seller uploads this information to the exchange server 104 using the first client program 1200 which is in communication with the server program 1230. In addition, the metal seller may upload information about preexisting credit relationships he has established with certain metal buyers. Subsequently, an authorized metal buyer downloads information about one or more lots of metal he may wish to buy using another client program 1260 which is also in communication with the server program 1230. Although the metal seller's identity is preferably unknown to the metal buyer (i.e., the seller remains anonymous at least until after a transaction is completed), an icon is preferably placed next to metal lots belonging to a metal seller who has a preexisting credit relationship with the metal buyer. In addition, the metal buyer may download other information such as price indices, hedge information, financing information, etc., all from within the same web site. If the metal buyer purchases a metal lot, the appropriate accounts are updated and the parties are informed. In addition, the buyer and/or the seller may receive updated portfolio valuations and/or mark to market analysis. Through the interaction of the programs 1200, 1230, 1260, as described below, complete price transparency for metals is provided. Accordingly, the system allows for the exchange of derivative contracts which are fully compliant with FAS 133.

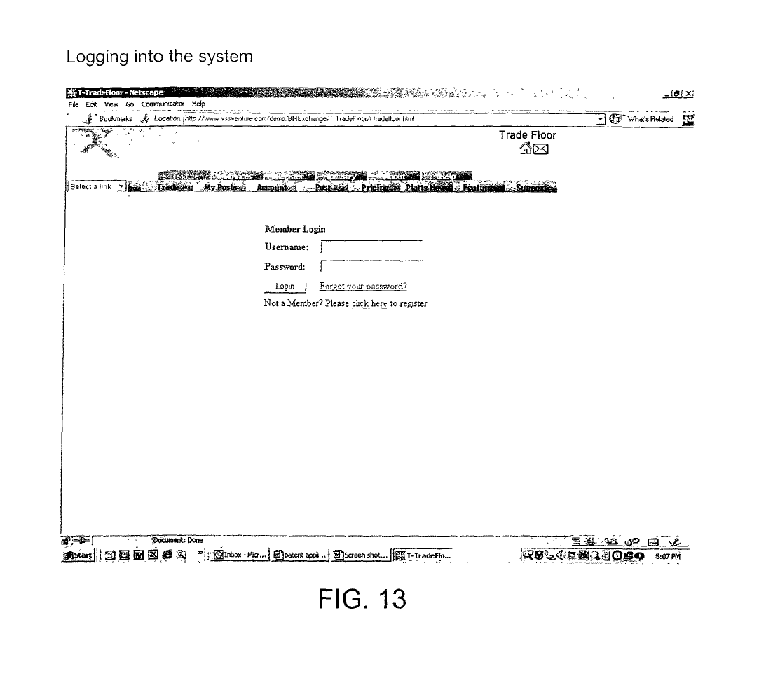

Although in practice the operation of the programs 1200, 1230, 1260 is essentially asynchronous, in this description program 1200 begins the overall process when a metal seller logs into the metals exchange server 104 from a first client device 102. Preferably, this log in step is accomplished by transmitting a username and/or a password to the server program 1230 via the network 108 (step 1202). A screen-shot of an exemplary web page used for logging into the system is illustrated in FIG. 13. Once the server 104 receives the username and password (step 1204), the server program 1230 verifies that the username and password belong to a registered user by checking the database 314 (step 1206).

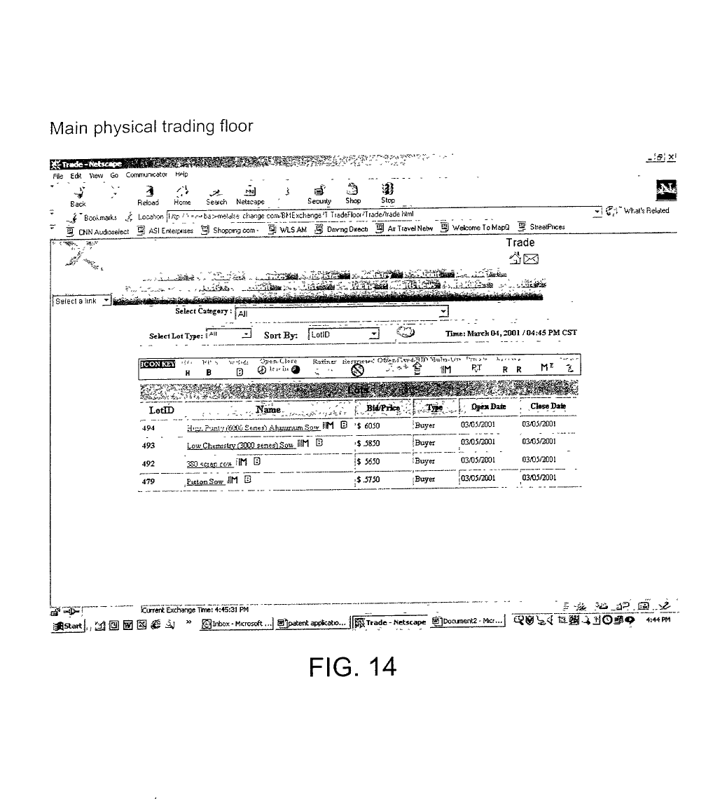

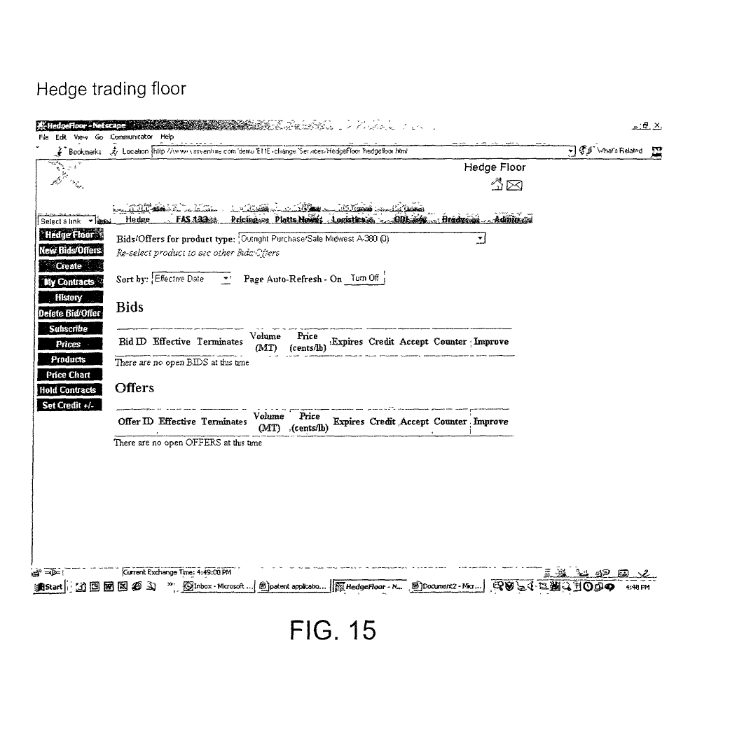

If the username and password are registered, the server program 1230 transmits one or more web pages to the metal seller (step 1208) for display at the first client device 102 (step 1210). A screen-shot of an exemplary web page showing the main physical trading floor is illustrated in FIG. 14. A screen-shot of an exemplary web page showing the hedge trading floor is illustrated in FIG. 15. Preferably, the server program 1230 starts by transmitting a “home” page. The home page is typically the top level in a hierarchical collection of related web pages called a web site. The majority of these related web pages are typically served from the same network domain (e.g., metalsexchange.com). After receiving the home page, the client 102 may request additional web pages from the web site by selecting hyperlinks embedded in previously received web pages in a well known manner. Preferably, the metals exchange server 104 serves web pages which include price indices, blank credit relationship form(s), blank metal seller's form(s), payment guarantees, and/or completed chemical evaluation matrices.

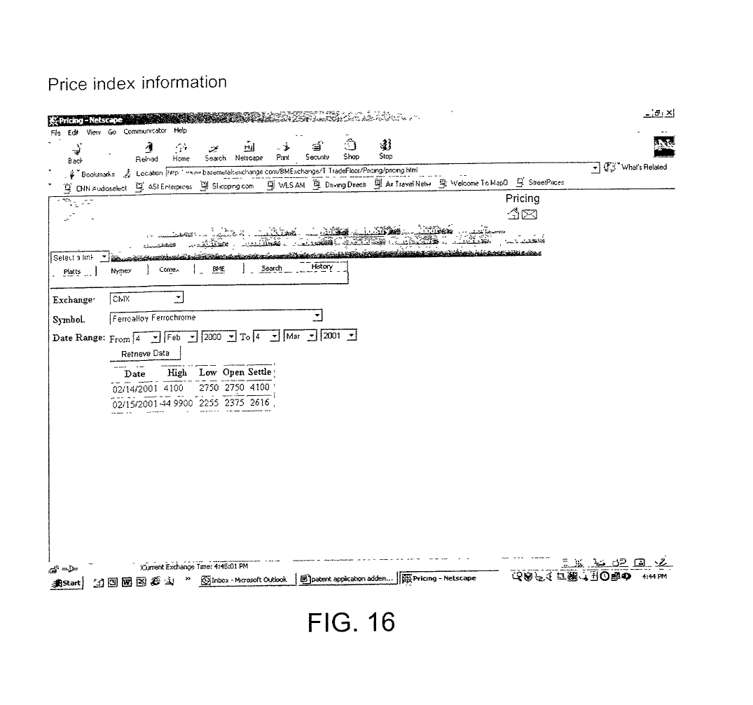

Preferably, each price index is a weighted moving average associated with a specific type of metal based on all exchanges processed by the exchange server 104 over a given period of time. For example, if the index for aluminum:casting:319.1 is based on a ten day moving average, and the metals exchange server 104 facilitated the purchase of one ton of aluminum:casting:319.1 for each of previous ten days at a price of $0.70/pound, and the metals exchange server 104 facilitated the purchase of ten tons of aluminum:casting:319.1 on one of the last ten days at a price of $0.60/pound, then the aluminum:casting:319.1 index would be $0.65/pound. A screen-shot of an exemplary web page showing price index information is illustrated in FIG. 16. Of course, a person of ordinary skill nit he art will readily appreciate that the price index may be computed in any well known manner. For example, the high and low price for a particular metal from the previous day may be listed.

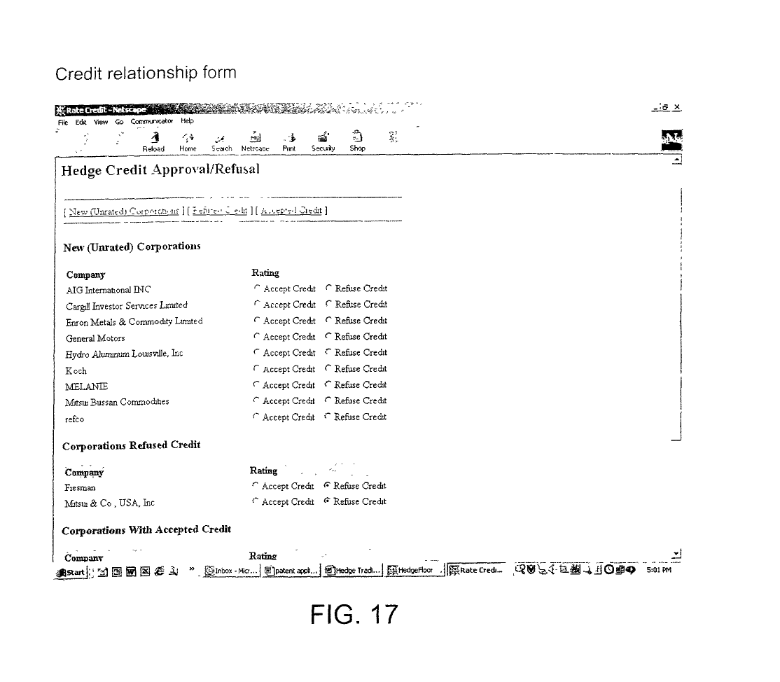

A credit relationship form represents a group of database fields which may be supplied by a metal seller to indicate that a preexisting bilateral credit relationship exists between that metal seller and one or more metal buyers (step 1212). For example, seller A may indicate that he has extended a line of credit to buyer B in the amount of $750,000. The buyer's use of this credit line may be tracked by the server 104 and used to display credit relationship icons next to anonymous metal lots as described in detail below. If the server 104 receives credit relationship information, the server program 1230 stores the information for later use (step 1214). A screen-shot of an exemplary web page showing a credit relationship form is illustrated in FIG. 17.

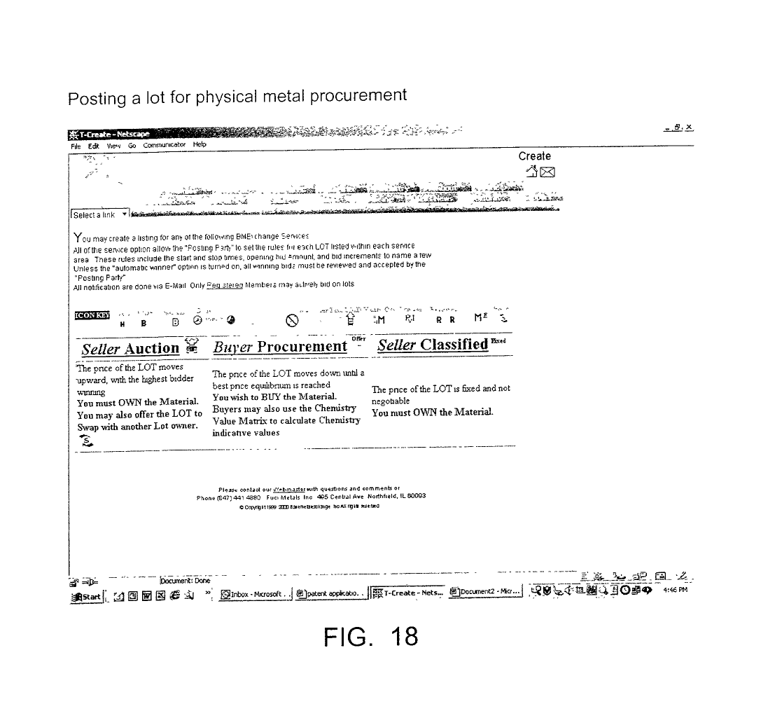

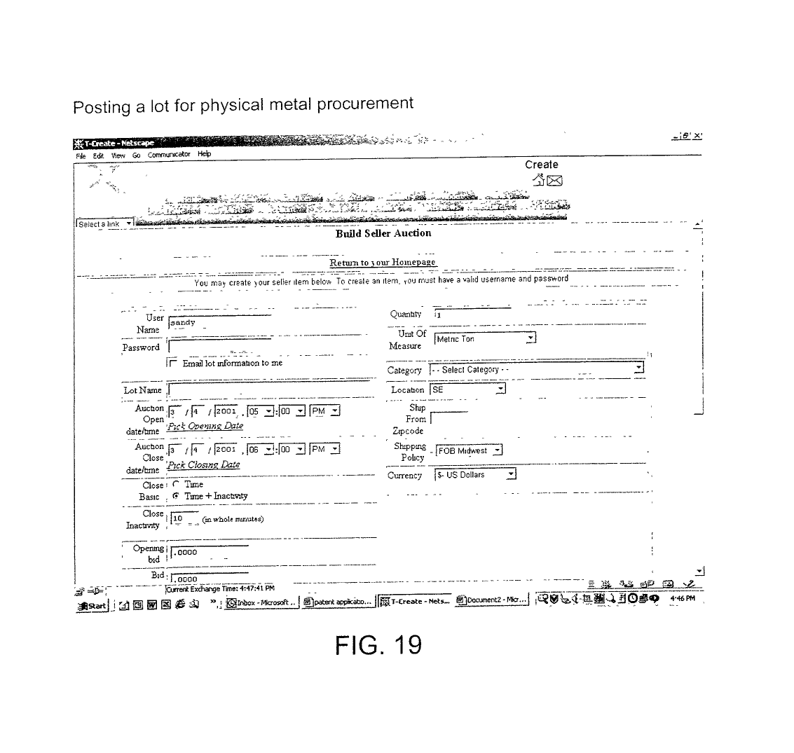

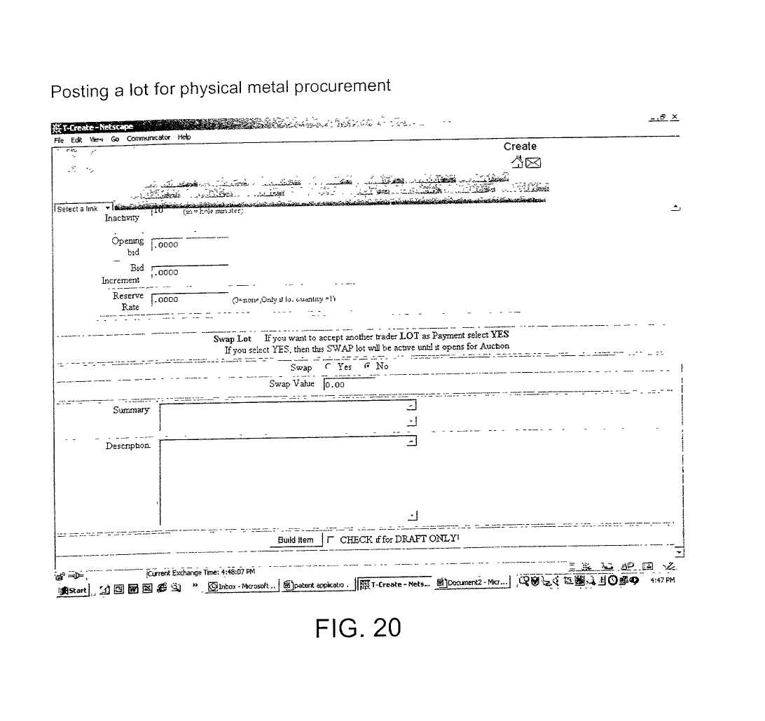

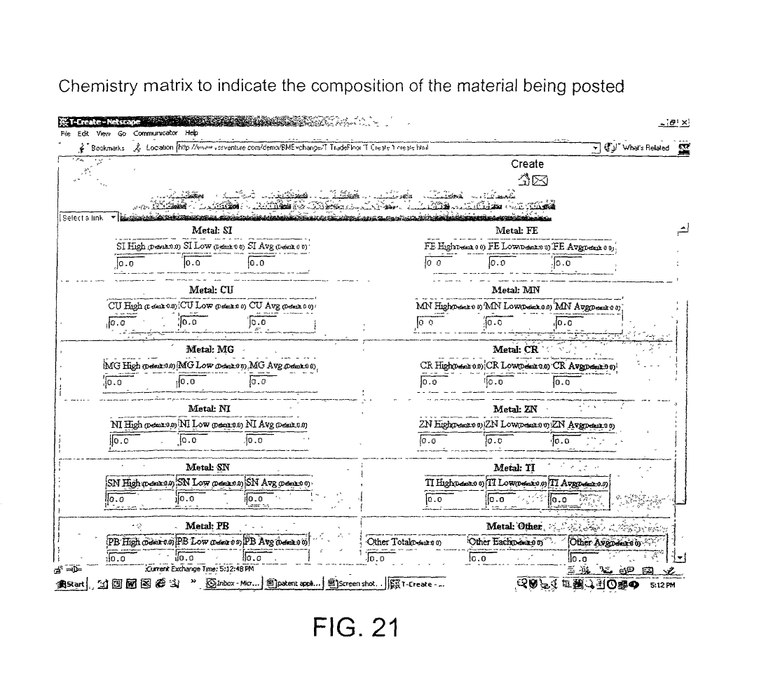

Preferably, the metal seller communicates his available metal lots to the server program 1230 by transmitting metal identification information to the metals exchange server 104 using a metal seller's form (step 1216). Metal identification information typically includes a metal type, a metal weight, a price, and a chemistry. For example, a seller may indicate that he has ten metric tons of aluminum:casting:319.1 containing less than 5% iron and less than 1% lead for sale at $0.71/pound. Similarly, platinum group metals may be specified. A series of screen-shots of exemplary web pages used for posting a metal lot to the exchange server 104 for physical metal procurement are illustrated in FIGS. 18-20. A screen-shot of an exemplary web page showing a form for identifying the chemistry of a metal lot to be posted is illustrated in FIG. 21.

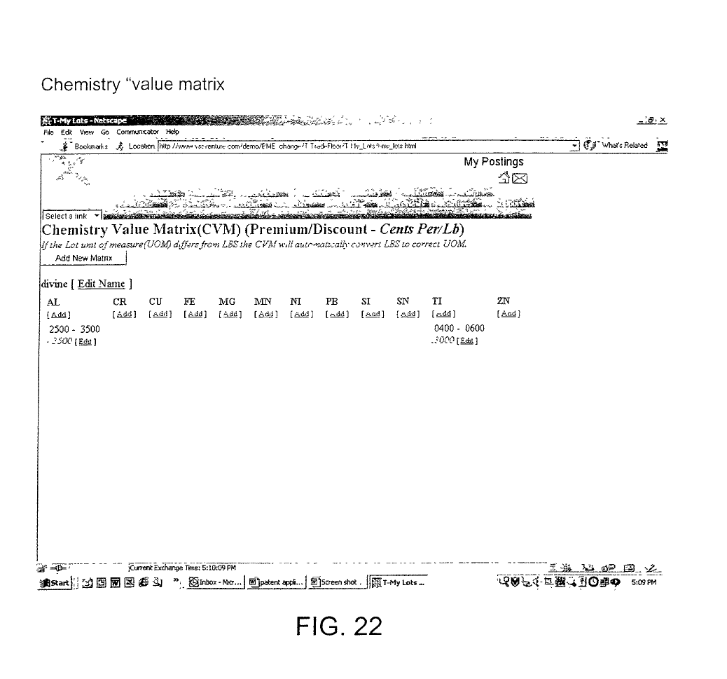

When determining the price for a particular metal lot, the metal seller may review chemical evaluation matrices which have been completed by a prospective metal buyer. A completed chemical evaluation matrix informs the metal seller what types and percentages of impurities matter most and/or least to a particular metal buyer based on that metal buyer's application. Additionally, the completed chemical evaluation matrix indicates an expected discount rate for one or more types and percentages of impurities. For example, a prospective metal buyer may indicate that he is looking to buy one ton of aluminum:casting:319.1 with less than 1% iron for $0.73/pound, but one ton of aluminum:casting:319.1 with less than 5% iron would satisfy his needs if the price was only $0.69/pound (i.e., a 4 cent/pound discount rate is expected). A screen-shot of an exemplary web page showing a chemistry value matrix is illustrated in FIG. 22.

Once the metal identification information is received by the exchange server 104, the server program 1230 stores the metal identification information in the server memory 308 and/or the separate database 314 (step 1218). Subsequently, a metal buyer logs into the metals exchange server 104 from a second client device 102. As with the metal seller, this log in step may be accomplished by transmitting a username and/or a password to the server program 1230 via the network 108 (step 1220). Again, once the server 104 receives the username and password (step 1222), the server program 1230 verifies that the username and password belong to a registered user by checking the local database 314 (step 1224). See FIG. 13.

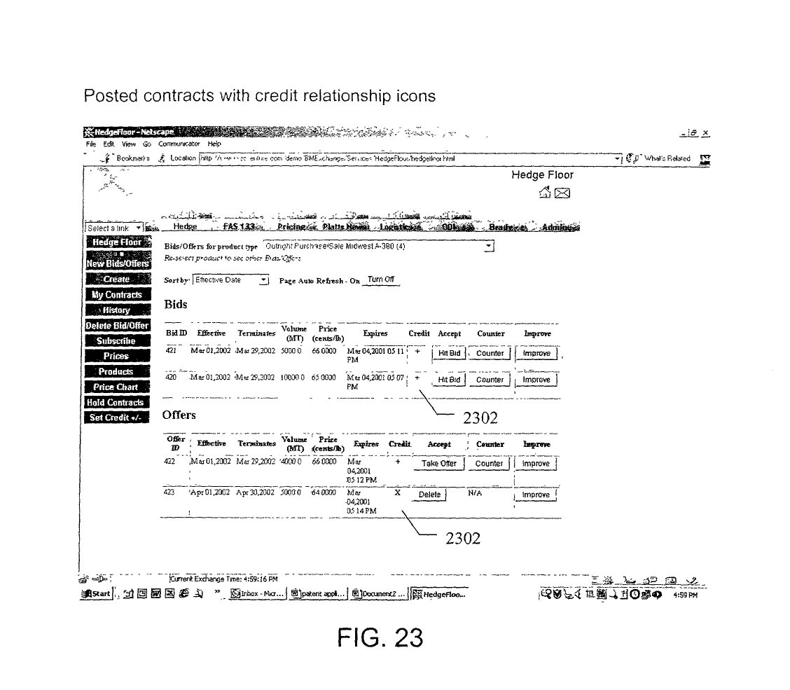

If the username and password are registered, the server program 1230 preferably determines if a bilateral credit relationship exists between the buyer and the seller (step 1226). This determination is made by checking if information defining such a bilateral credit relationship was stored in the database 312 earlier at step 1214. In the example above, seller A extended a $750,000 line of credit to buyer B. If a credit relationship exists, a visual indicator, such as a credit relationship icon, is preferably placed next to otherwise anonymous metal lots to indicate that the lot may be purchased using the previously established credit line. A screen-shot of an exemplary web page showing posted contracts with credit relationship icons 2302 is illustrated in FIG. 23. Of course, a person of ordinary skill in the art will readily appreciate that other forms of credit may be used without departing from the scope or spirit of the present invention. For example, a clearinghouse may be used. Alternatively, certain frequent metal buyers, such as automobile manufactures, may establish an account with the metals exchange server 104 and place a certain amount of capital in the account. Subsequently, when one of these buyers purchases metal via the metals exchange server 104, the purchase price may be automatically deducted from the user's pre-established account.

Subsequently, the server program 1230 transmits one or more web pages to the metal buyer (step 1228) for display at the second client device 102 (step 1230). Again, the server program 1230 may start by transmitting a “home” page. After receiving the home page, the client 102 may request additional web pages from the web site by selecting hyperlinks embedded in the web pages. Preferably, the metals exchange server 104 serves web pages which include price indices, metal identification information with credit relationship icons 2302, hedging services, logistics services, FAS133 information, financing services, and/or a blank chemical evaluation matrix. Preferably, the seller's identify is not included (i.e., all sellers remain anonymous prior to lot purchase). As discussed above, each price index is preferably a weighted moving average associated with a specific type of metal based on all exchanges processed by the exchange server 104 over a given period of time.

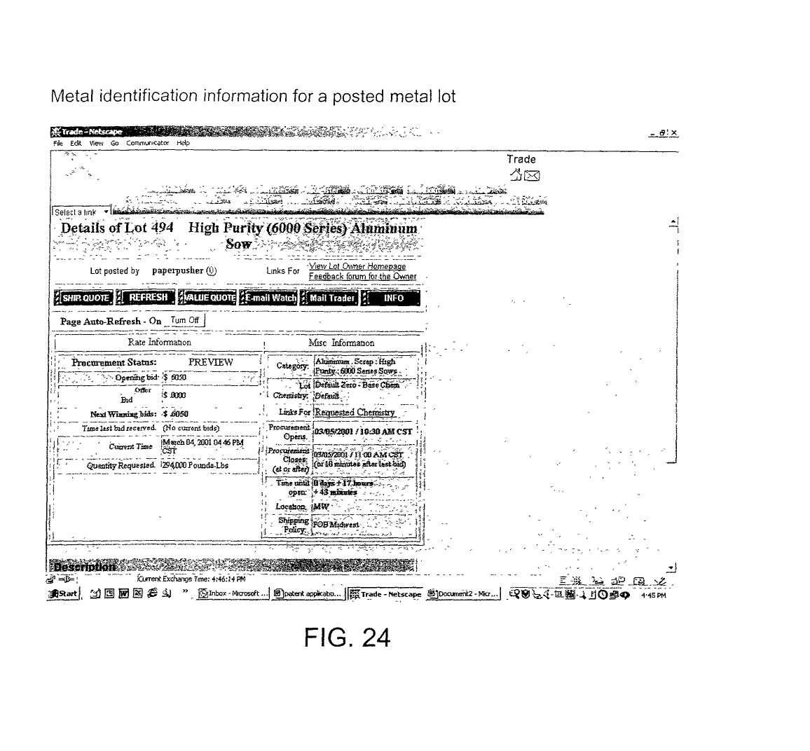

Metal identification information typically includes a metal type, a metal weight, a price, and a chemistry. A screen-shot of an exemplary web page showing metal identification information is illustrated in FIG. 24. The chemistry composition of a particular metal is preferably detailed on a separate composition web page which may be retrieved by activating a hyperlink associated with the metal lot. For example, the composition web page may indicate percentages and or ranges for silicon, copper, magnesium, nickel, tin, lead, iron, manganese, chromium, zinc, and/or titanium. See FIG. 21. In addition, the metal identification information may be associated with a credit relationship icon 2302. See FIG. 23.

Preferably, the exchange server 104 transmits three different types of credit relationship icons 2302. If a preexisting bilateral credit relationship exists between the buyer (i.e., the viewer of the transmitted web page) and the seller (i.e., the person who posted the metal lot in question), then a positive icon may be used (e.g., “+”). Conversely, if a preexisting bilateral credit relationship does not exist between the buyer and the seller, then no icon or a negative icon may be used (e.g., “−”). If the viewer of the transmitted web page is looking at a metal lot he himself posted, then a neutral icon may be used (e.g., “×”). See FIG. 23. Preferably, the current status of credit accounts are maintained in the database 314. In this manner, the positive icon may be reserved for metal lots which, if purchased, would not cause the established credit limit to be exceeded.

If requested by the buyer, the exchange server 104 may transmit a blank chemical evaluation matrix to the client 102. The blank chemical evaluation matrix may be completed by the metal buyer and transmitted back to the server 104 (step 1232). The completed chemical evaluation matrix informs metal sellers what types and percentages of impurities matter most and/or least to this metal buyer. Additionally, the completed chemical evaluation matrix indicates an expected discount rate for one or more types and percentages of impurities. Once received by the exchange server 104, the completed chemical evaluation matrix is stored in the database 314 for subsequent review by interested metal sellers (step 1234). See FIG. 22.

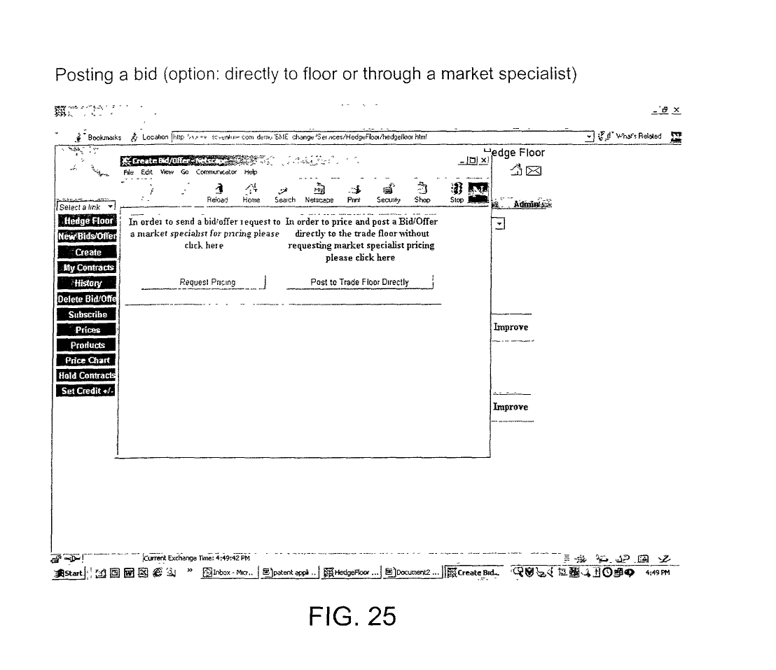

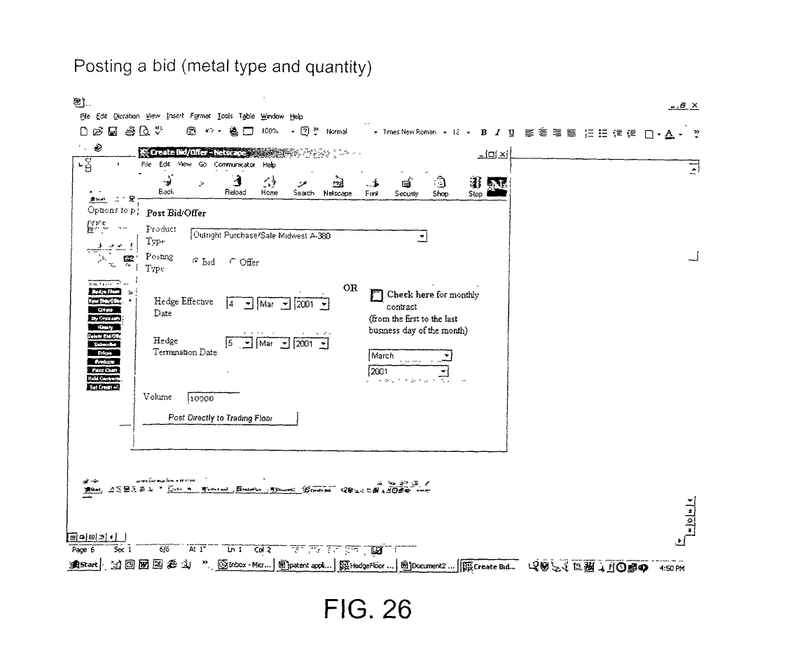

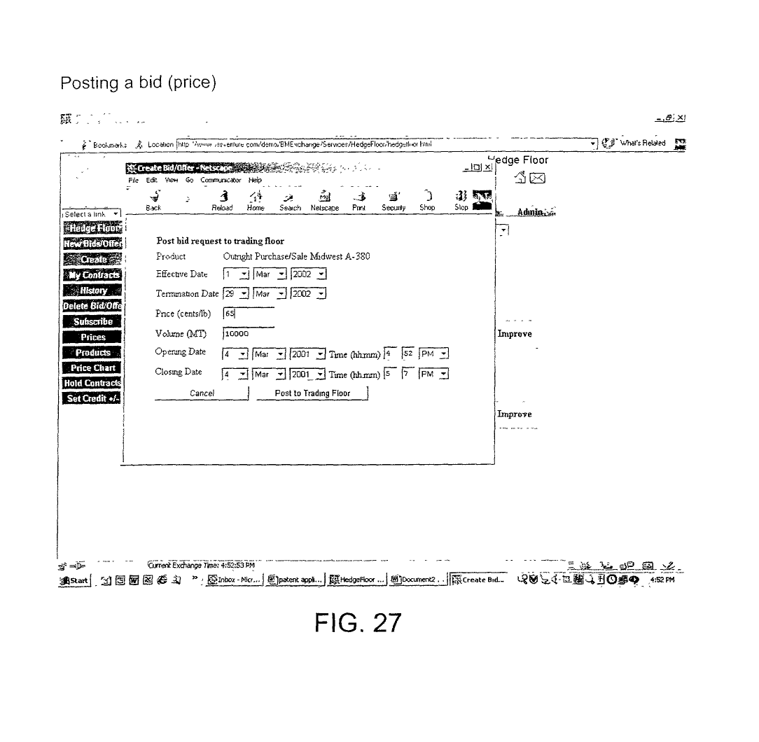

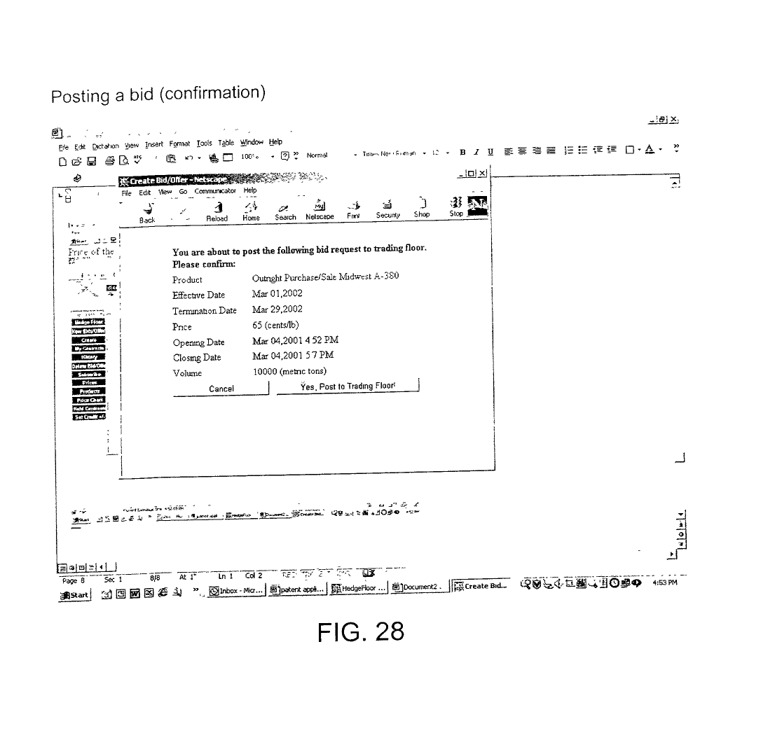

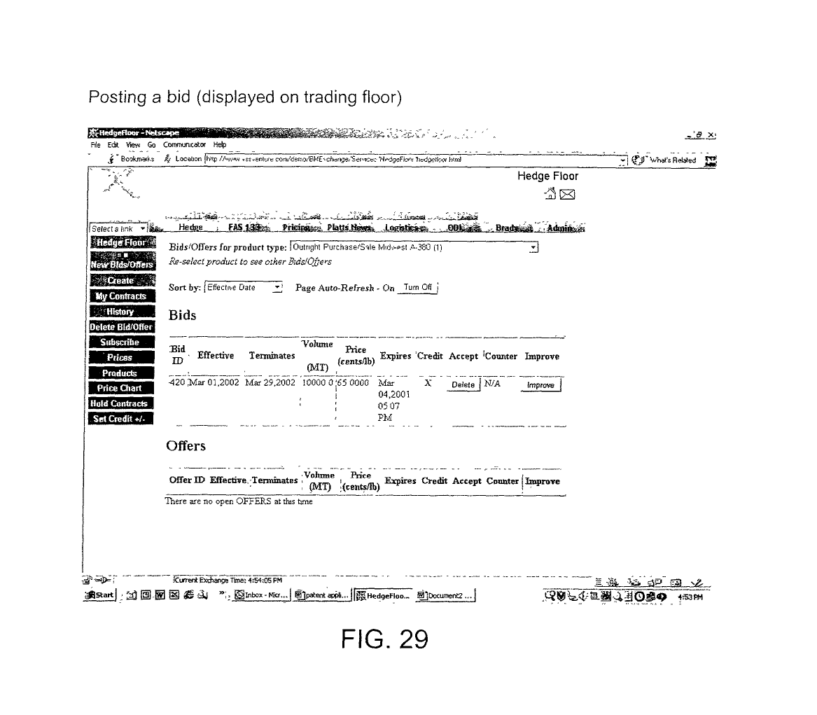

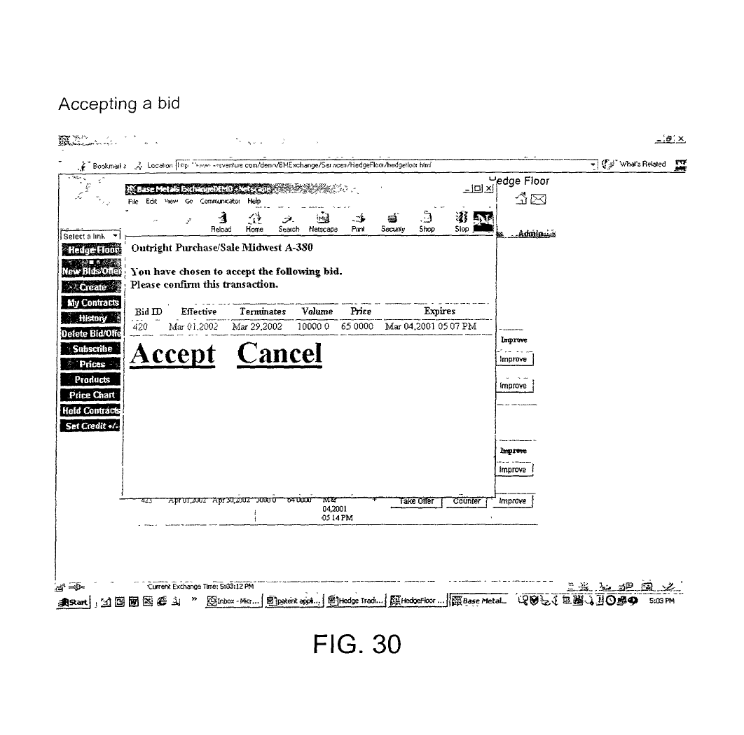

Once a metal buyer locates a metal lot he wishes to purchase, he may transmit a bid signal or a buy signal to the exchange server 104 (step 1236). A bid signal is used if the desired metal lot is listed in an auction. A buy signal is used if the desired metal lot is listed as a classified item. In either case, the signal is received by the exchange server 104 and stored in the database 314 (step 1238). A series of screen-shots of exemplary web pages used to submit a bid is illustrated in FIGS. 25-29. Preferably, the seller must accept the bid before the purchase is complete. A screen-shot of an exemplary web page used to accept a bid is illustrated in FIG. 30. Of course, a person of ordinary skill in the are will readily appreciate that essentially the same process may occur in reverse (i.e., the metal seller posts a desired lot and a metal seller agrees to supply the desired lot).

In response to a metal purchase, several steps are taken by the exchange server 104. If a purchase is made on credit, a credit account stored in the database 314 is preferably updated (step 1240). In this manner, the positive credit relationship icon may be reserved for metal lots which, if purchased, would not cause the established credit limit to be exceeded. Preferably, the exchange server 104 also transmits metal exchange transaction information to a plurality of registered users to provide complete price transparency (e.g., to all registered users who request the information). The metal exchange transaction information typically includes a plurality of metal lot records. Each metal lot record preferably includes a lot type, a lot quantity, a lot price, and an exchange date.

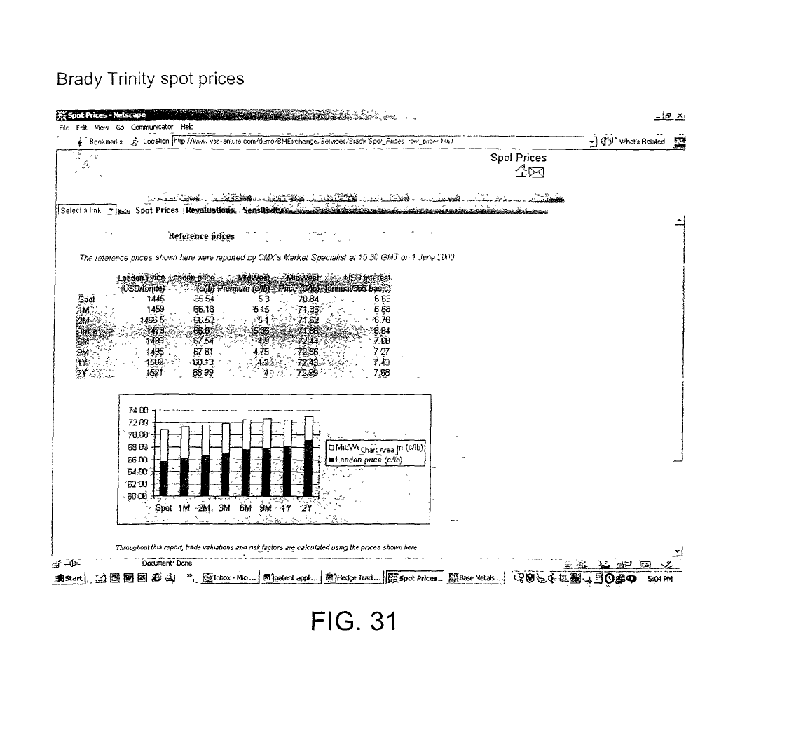

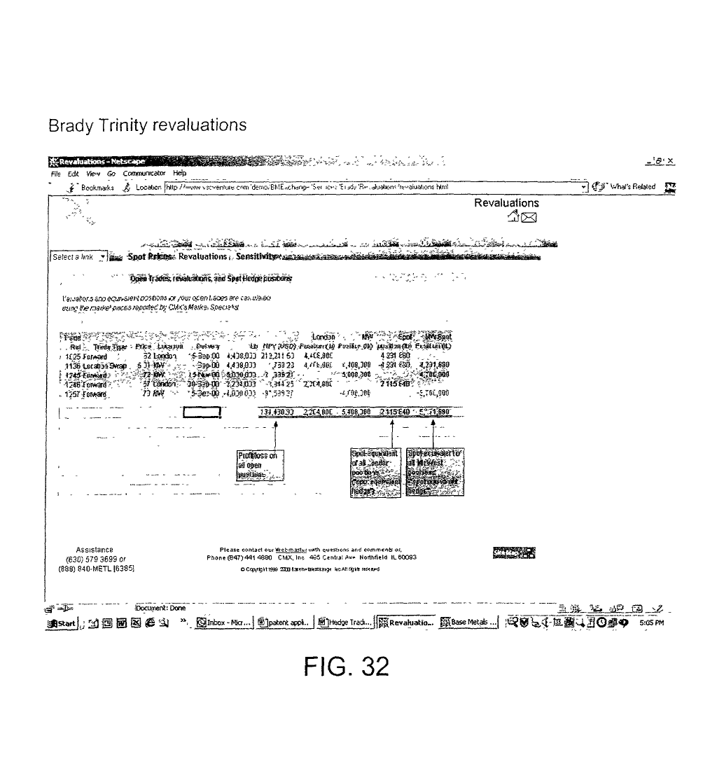

In addition, portfolio valuations and mark to market analysis may be performed on the updated portfolios of both the buyer and the seller in a well known manner (step 1242). The exchange server 104 then transmits confirmation information, account status information, portfolio updates, and/or mark to market updates to the buyer and/or the seller (step 1244) for display on their respective client devices 102 (step 1246). A screen-shot of an exemplary web page showing Brady Trinity spot prices is illustrated in FIG. 31, and a screen-shot of an exemplary web page showing a Brady Trinity revaluation is illustrated in FIG. 32.

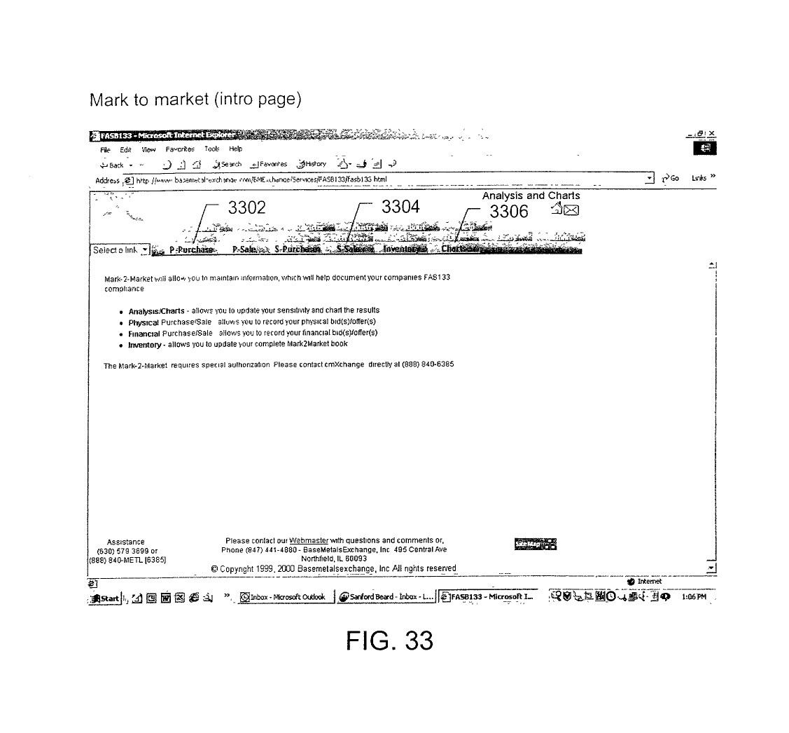

A more detailed series of screen-shots showing exemplary web pages used for facilitating portfolio valuations and mark to market analysis are illustrated in FIGS. 33-40. The mark to market tool illustrated allows a user to maintain a running total of his position and exposure in the market for both financial and physical products. The data required by the mark to market tool may be downloaded from the exchange database 314 or loaded manually at a client device 102. In this example, using Brady Trinity software, the data is loaded manually.

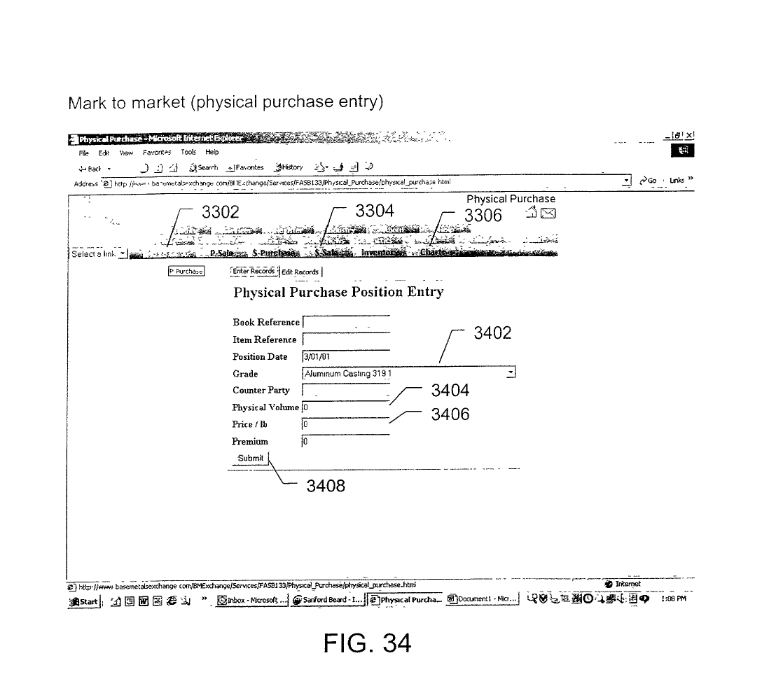

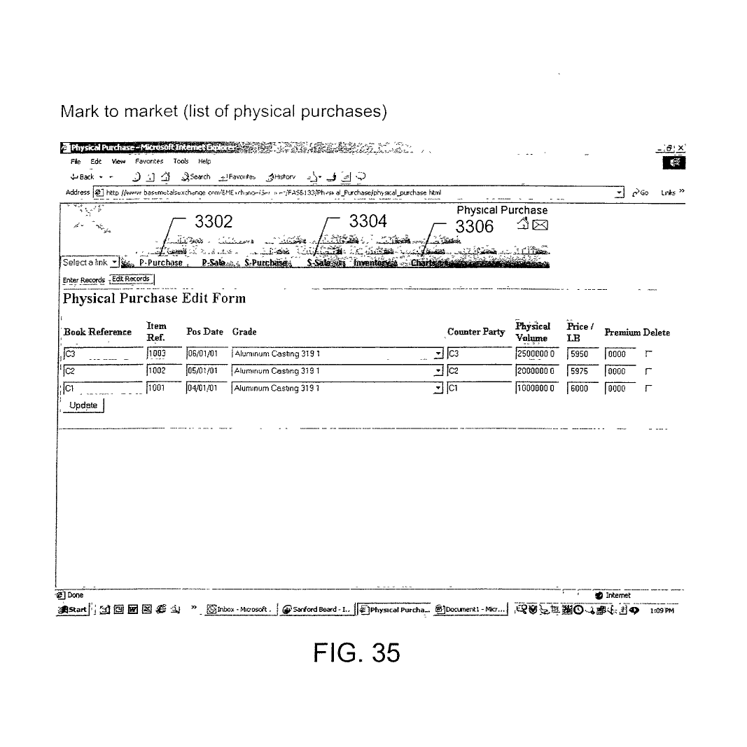

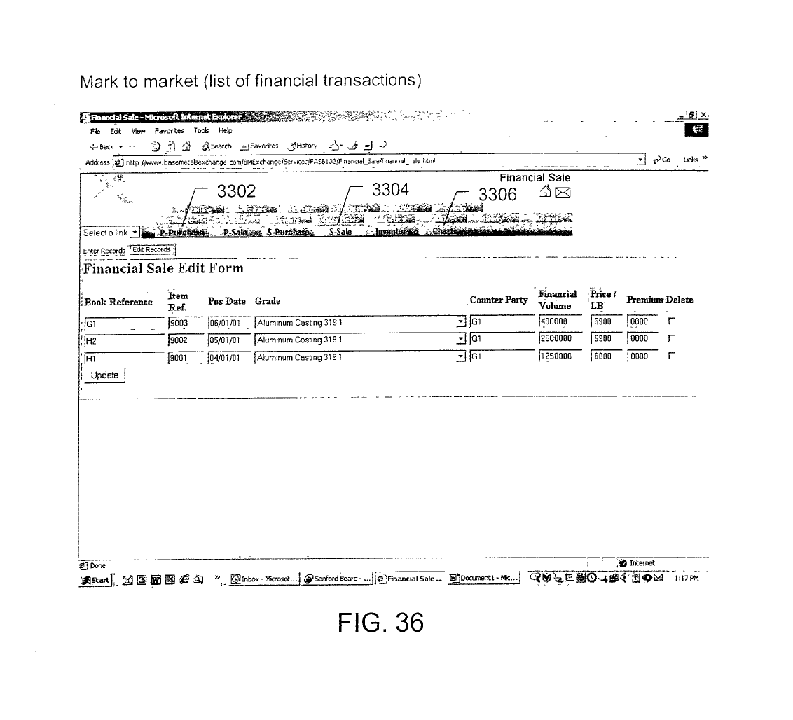

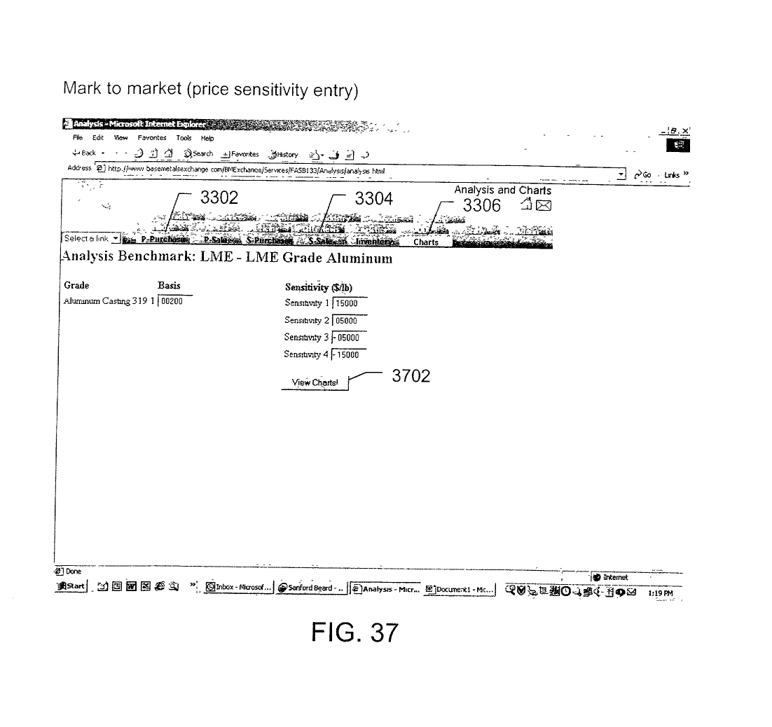

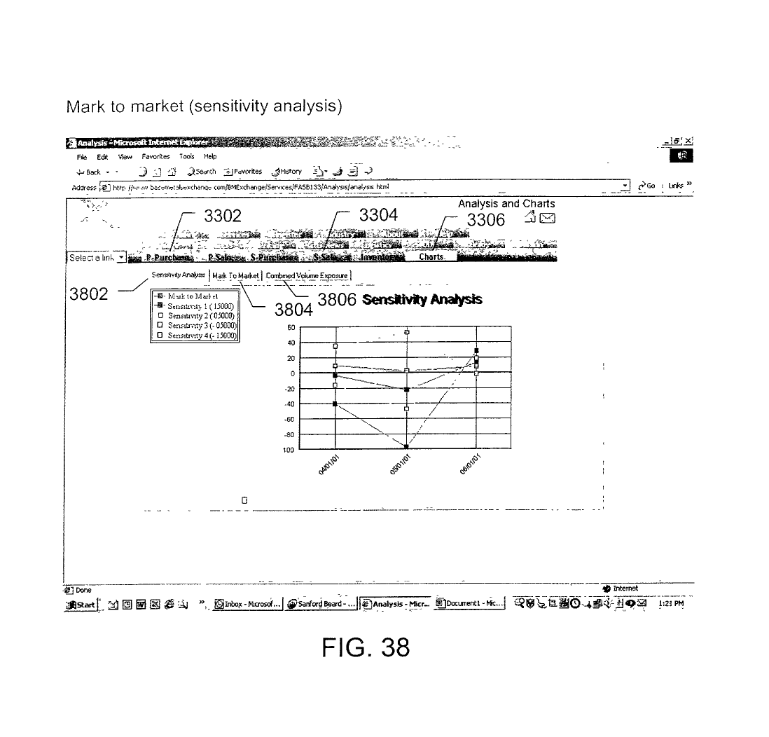

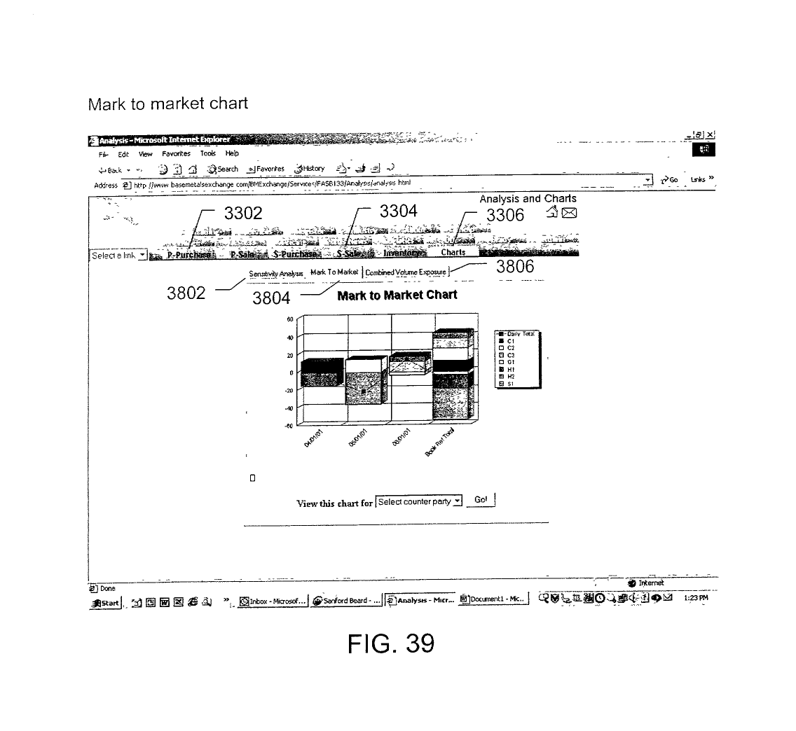

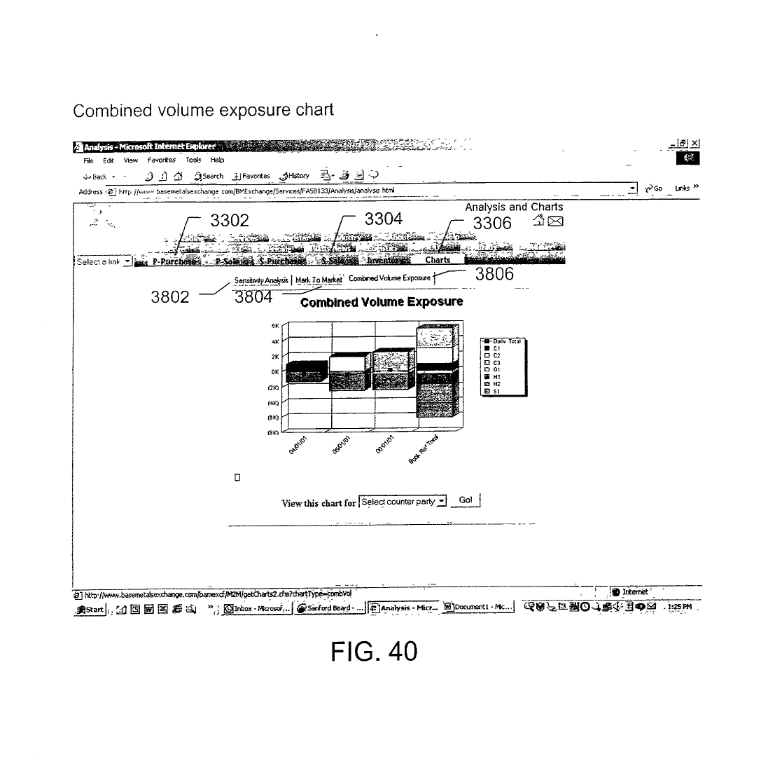

Initially, the user is presented with a mark to market introduction page (see FIG. 33). By selecting a “P-Purchase” hyperlink 3302 on the introduction page, the user is presented with a physical purchase entry page (see FIG. 34). Preferably, the user enters information identifying a particular metal purchase using the physical purchase entry page. For example, the user may be asked to enter the metal type 3402, metal amount 3404, and metal price 3406 using the physical purchase entry page. Subsequently, the user selects a “Submit” hyperlink 3408 which calls up a list of previously made physical purchases (see FIG. 35). In addition, the user may select an “S-Sale” hyperlink 3304 to see a list of financial transactions (see FIG. 36). Further, the user may select a “Charts” hyperlink 3306 to enter price sensitivities (e.g., cents/pound price movements) which are used to generate graphs (see FIG. 37). On the price sensitivity entry page, the user may select a “View Charts” hyperlink 3702 to request a chart showing price sensitivities over time (see FIG. 38). This chart is preferably the default chart, and the user may return to this chart by selecting a Sensitivity Analysis” tab 3802. In addition, the user may select a “Mark to Market” tab 3804 and a “Combined Volume Exposure” tab 3806. The “Mark to Market” tab 3804 displays a total mark to market chart and a mark to market chart for each counter party (see FIG. 39). The “Combined Volume Exposure” tab 3806 displays a total combined volume chart and a combined volume chart for each counter party (see FIG. 40).

In summary, persons of ordinary skill in the art will readily appreciate that a method and apparatus for facilitating an exchange of metals via an electronic network has been provided. Users of systems implementing the teachings described herein can enjoy unencumbered access to a metals market with complete price transparency. True price indices are provided for non-standard metal alloys and product manufacturers are able to purchase derivative contracts which meet the requirements FAS133. As a result, on average, metal sellers are able sell at higher prices and metal buyers are able to buy at lower prices than previously possible, because the middle man is eliminated and market information is allowed to flow freely.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited not by this detailed description, but rather by the claims appended hereto.

What is claimed is:

1. A method of exchanging metals comprising the steps of:
receiving a first user name and a first password from a metal seller;
verifying the first user name and the first password against a database of authorized users;
receiving metal identification information from the metal seller, the metal identification information including a metal type, a metal weight, and a price;
receiving a second user name and a second password from a metal buyer;
verifying the second user name and the second password against the database of authorized users;
determining if a preexisting credit relationship exists between the metal buyer and the metal seller; and
transmitting a metals exchange web page to the metal buyer, the metals exchange web page including the metal identification information and an icon if a preexisting credit relationship exists between the metal buyer and the metal seller.

2. A method of exchanging metals as defined in claim 1, wherein the step of transmitting a metals exchange web page to the metal buyer comprises the step of transmitting a positive icon if a preexisting credit relationship exists between the metal buyer and the metal seller.

3. A method of exchanging metals as defined in claim 1, wherein the step of transmitting a metals exchange web page to the metal buyer comprises the step of transmitting a negative icon if a preexisting credit relationship does not exist between the metal buyer and the metal seller.

4. A method of exchanging metals as defined in claim 1, wherein the step of determining if a preexisting credit relationship exists between the metal buyer and the metal seller comprises the step of determining if a bilateral credit relationship exists between the metal buyer and the metal seller

5. A method of exchanging metals as defined in claim 1, wherein the step of transmitting a metals exchange web page to the metal buyer comprises the step of making the metal seller anonymous to the metal buyer.

6. A method of exchanging metals as defined in claim 1, further comprising the step of receiving credit relationship information from the metal seller, the credit relationship information identifying a metal buyer and a credit threshold.

7. A method of exchanging metals as defined in claim 6, further comprising the steps of:
maintaining a current credit balance between the metal buyer and metal seller; and
determining if processing a purchase associated with the metal identification information by the metal buyer would exceed the credit threshold of the preexisting credit relationship between the metal buyer and the metal seller.

8. A method of exchanging metals as defined in claim 7, wherein the step of transmitting a metals exchange web page to the metal buyer comprises the step of making the metal seller anonymous to the metal buyer.

9. A method of exchanging metals as defined in claim 1, further comprising the steps of receiving a metal chemistry composition from the metal seller and transmitting the metal chemistry composition to the metal buyer.

10. A method of exchanging metals as defined in claim 1, further comprising the step of transmitting metal exchange transaction information to a plurality of registered users to provide price transparency, the metal exchange transaction information including a plurality of metal lot records, each metal lot record including a lot type, a lot quantity, a lot price, and an exchange date.

11. A method of exchanging metals as defined in claim 1, wherein the step of transmitting a metals exchange web page to the metal buyer comprises the step of transmitting a hyperlink, the hyperlink pointing to a metals hedging web page.

12. A method of exchanging metals as defined in claim 1, wherein the step of transmitting a metals exchange web page to the metal buyer comprises the step of transmitting a hyperlink, the hyperlink pointing to a logistics web page.

13. A method of exchanging metals as defined in claim 1, further comprising the step of transmitting a purchase selection for a FAS133 compliant derivative contract.

14. A method of exchanging metals as defined in claim 1, further comprising the step of performing a portfolio valuation.

15. A method of exchanging metals as defined in claim 1, further comprising the step of performing a mark to market determination.

16. A method of exchanging metals as defined in claim 1, further comprising the step of providing a payment guarantee.

17. A method of exchanging metals as defined in claim 1, further comprising the step of providing a financing option.

18. A method of exchanging metals as defined in claim 1, further comprising the step of providing a weighted average price index based on the plurality of exchanges.

19. A method of exchanging metals comprising the steps of:
receiving a first user name and a first password from a metal seller;
verifying the first user name and the first password against a database of authorized users;
receiving metal identification information from the first user, the metal identification information including a metal type, a metal weight, a price, and a metal chemistry composition;
receiving a second user name and a second password from a metal buyer;
verifying the second user name and the second password against the database of authorized users; and
transmitting a metals exchange web page to the metal buyer, the metals exchange web page including the metal type, the metal weight, the price, and a hyperlink to a composition web page, the composition web page including the metal chemistry composition.

20. A method of exchanging metals as defined in claim 19, further comprising the steps of receiving a request for the composition web page from the metal buyer and transmitting the metal chemistry composition to the metal buyer.

21. A method of exchanging metals as defined in claim 20, wherein the step of transmitting the metal chemistry composition to the metal buyer comprises the step of transmitting a percentage of one of silicon, copper, magnesium, nickel, tin, lead, iron, manganese, chromium, zinc, and titanium.

22. A method of exchanging metals as defined in claim 20, wherein the step of transmitting the metal chemistry composition to the metal buyer comprises the step of transmitting a percentage of two of silicon, copper, magnesium, nickel, tin, lead, iron, manganese, chromium, zinc, and titanium.

23. A method of exchanging metals as defined in claim 20, wherein the step of transmitting the metal chemistry composition to the metal buyer comprises the step of transmitting a range for each of a plurality of elements from the periodic table of elements.

24. A method of exchanging metals as defined in claim 19, further comprising the steps of receiving a chemistry evaluation matrix from the metal buyer, the chemistry evaluation matrix including a desired discount associated with a particular metal percentage, and transmitting the chemistry evaluation matrix to the metal seller.

25. A method of exchanging metals as defined in claim 19, wherein the step of transmitting a metals exchange web page to the metal buyer comprises the step of making the metal seller anonymous to the metal buyer.

26. A method of exchanging metals as defined in claim 19, further comprising the step of transmitting metal exchange transaction information to a plurality of registered users to provide price transparency, the metal exchange transaction information including a plurality of metal lot records, each metal lot record including a lot type, a lot quantity, a lot price, and an exchange date.

27. A method of exchanging metals as defined in claim 19, wherein the step of transmitting a metals exchange web page to the metal buyer comprises the step of transmitting a hyperlink to a metals hedging web page.

28. A method of exchanging metals as defined in claim 19, wherein the step of transmitting a metals exchange web page to the metal buyer comprises the step of transmitting a hyperlink to a logistics web page.

29. A method of exchanging metals as defined in claim 19, further comprising the step of transmitting a purchase selection for a FAS133 compliant derivative contract.

30. A method of exchanging metals as defined in claim 19, further comprising the step of performing a portfolio valuation.

31. A method of exchanging metals as defined in claim 19, further comprising the step of performing a mark to market determination.

32. A method of exchanging metals as defined in claim 19, further comprising the step of providing a payment guarantee.

33. A method of exchanging metals as defined in claim 19, further comprising the step of providing a financing option.

34. A method of exchanging FAS133 compliant derivative contracts for metals, the method comprising the steps of:
processing a plurality of exchanges of a plurality metals between a plurality of metal buyers and a plurality of metal sellers;
providing a weighted average price index based on the plurality of exchanges in compliance with FAS133 requirements for market-based pricing; and
facilitating a purchase of a FAS133 compliant derivative contract online.

35. A method of exchanging FAS133 compliant derivative contracts as defined in claim 34, further comprising the step of providing real time price adjustments online, the real time price adjustments being based on a chemical composition associated with a particular metal from the plurality metals.

36. A method of exchanging FAS133 compliant derivative contracts as defined in claim 34, wherein the step of processing a plurality of exchanges of a plurality metals between a plurality of metal buyers and a plurality of metal sellers comprises the step of processing an exchange of a platinum group metal.

37. A method of exchanging FAS133 compliant derivative contracts as defined in claim 34, wherein the step of processing a plurality of exchanges of a plurality metals between a plurality of metal buyers and a plurality of metal sellers comprises the step of receiving a metal chemistry composition from a particular seller in the plurality of metal sellers and transmitting the metal chemistry composition to a particular buyer in the plurality of metal buyers.

38. A method of exchanging FAS133 compliant derivative contracts as defined in claim 37, wherein the step of receiving a metal chemistry composition comprises the step of receiving a percentage of one of silicon, copper, magnesium, nickel, tin, lead, iron, manganese, chromium, zinc, and titanium.

39. A method of exchanging FAS133 compliant derivative contracts as defined in claim 37, wherein the step of receiving a metal chemistry composition comprises the step of receiving a range for each of a plurality of elements from the periodic table of elements.

40. A method of exchanging FAS133 compliant derivative contracts as defined in claim 34, wherein the step of facilitating a purchase of a FAS133 compliant derivative contract online comprises the step of maintaining anonymity of both a buyer associated with the purchase and a seller associated with the purchase.

41. A method of exchanging FAS133 compliant derivative contracts as defined in claim 40, further comprising the step of transmitting an icon indicative of a preexisting bilateral credit arrangement between the buyer and the seller.

42. A method of exchanging FAS133 compliant derivative contracts as defined in claim 40, further comprising the step of transmitting metal exchange transact ion information to a plurality of registered users to provide price transparency, the metal exchange transaction information including a plurality of metal lot records, each metal lot record including a lot type, a lot quantity, a lot price, and an exchange date.

43. A method of exchanging FAS133 compliant derivative contracts as defined in claim 34, further comprising the step of transmitting a hedging web page.

44. A method of exchanging FAS133 compliant derivative contracts as defined in claim 34, further comprising the step of transmitting a logistics web page.

45. A method of exchanging FAS133 compliant derivative contracts as defined in claim 34, further comprising the step of performing a portfolio valuation.

46. A method of exchanging FAS133 compliant derivative contracts as defined in claim 34, further comprising the step of performing a mark to market determination.

47. A method of exchanging FAS133 compliant derivative contracts as defined in claim 34, further comprising the step of providing a payment guarantee.

48. A method of exchanging FAS133 compliant derivative contracts as defined in claim 34, further comprising the step of providing a financing option.

49. A metals exchange server comprising:
a network transmitter;
a network receiver;
a memory device storing a software program and registered user information; and
a processor operatively coupled to the network transmitter, network receiver, and memory device, the processor being structured to execute the software program, the software program being structured to cause the processor to:
(i) receive login information from a metal seller and a metal buyer via the network receiver;
(ii) verify the login information matches the registered user information stored in the memory device;
(iii) receive metal identification information from the metal seller via the network receiver, the metal identification information including a metal type, a metal weight, and a price;
(iv) store the metal identification information in the memory device;
(v) determine if a preexisting credit relationship exists between the metal buyer and the metal seller using the registered user information stored in the memory device; and
(vi) transmit a metals exchange web page to the metal buyer via the network transmitter, the metals exchange web page including the metal identification information and a positive icon if a preexisting credit relationship exists between the metal buyer and the metal seller, the metals exchange web page including the metal identification information and a negative icon if a preexisting credit relationship does not exist between the metal buyer and the metal seller.

50. A metals exchange server as defined in claim 49, wherein the software program is further structured to cause the processor to receive a credit limit associated with the metal buyer from the metal seller via the network receiver.

51. A metals exchange server as defined in claim 50, wherein the software program is further structured to cause the processor to maintain a current credit balance between the metal buyer and metal seller and determine if processing a purchase associated with the metal identification information by the metal buyer would exceed the credit limit.

52. A metals exchange server as defined in claim 49, wherein the software program is further structured to cause the processor to receive a metal chemistry composition from the metal seller via the network receiver and transmit the metal chemistry composition to the metal buyer via the network transmitter.

53. A metals exchange server as defined in claim 49, wherein the software program is further structured to cause the processor to transmit metal exchange transaction information to a plurality of registered users via the network transmitter to provide price transparency, the metal exchange transaction information including a plurality of metal lot records, each metal lot record including a lot type, a lot quantity, a lot price, and an exchange date.

54. A metals exchange server as defined in claim 49, wherein the software program is further structured to cause the processor to transmit a hyperlink to web page via the network transmitter, the web page offering to sell at least one of a metals hedging contract, a logistics contract, and a FAS133 compliant derivative contract.

55. A metals exchange server as defined in claim 49, wherein the software program is further structured to cause the processor to perform at lest one of a portfolio valuation and a mark to market determination.

56. A metals exchange server as defined in claim 49, wherein the software program is further structured to cause the processor to transmit at least one of a payment guarantee to the metal seller and a financing option to the metal buyer via the network transmitter.

57. A metals exchange server comprising:
a network transmitter;
a network receiver;
a memory device storing a software program and registered user information; and
a processor operatively coupled to the network transmitter, network receiver, and memory device, the processor being structured to execute the software program, the software program being structured to cause the processor to:
(i) receive login information from a metal seller and a metal buyer via the network receiver;
(ii) verify the login information matches the registered user information stored in the memory device;
(iii) receive metal identification information from the metal seller via the network receiver, the metal identification information including a metal type, a metal weight, a price, and a metal chemistry composition;
(iv) store the metal identification information in the memory device; and
(v) transmit the metal type, the metal weight, the price, and the metal chemistry composition to the metal buyer via the network transmitter.

58. A metals exchange server as defined in claim 57, wherein the software program is further structured to cause the processor to transmit a percentage of one of silicon, copper, magnesium, nickel, tin, lead, iron, manganese, chromium, zinc, and titanium to the metal buyer via the network transmitter.

59. A metals exchange server as defined in claim 57, wherein the software program is further structured to cause the processor to receive a chemistry evaluation matrix from the metal buyer via the network receiver, the chemistry evaluation matrix including a desired discount associated with a particular metal percentage.

60. A metals exchange server as defined in claim 57, wherein the software program is further structured to cause the processor to transmit metal exchange transaction information to a plurality of registered users via the network transmitter to provide price transparency, the metal exchange transaction information including a plurality of metal lot records, each metal lot record including a lot type, a lot quantity, a lot price, and an exchange date.

61. A metals exchange server as defined in claim 57, wherein the software program is further structured to cause the processor to transmit an offer to sell at least one of a metals hedging contract, a logistics contract, and a FAS133 compliant derivative contract.

62. A metals exchange server as defined in claim 57, wherein the software program is further structured to cause the processor to perform at least one of a portfolio valuation and a mark to market determination.

63. A metals exchange server as defined in claim 57, wherein the software program is further structured to cause the processor to transmit at least one of a payment guarantee to the metal seller and a financing option to the metal buyer via the network transmitter.

64. A metals exchange server comprising:
a network transmitter;
a network receiver;
a memory device storing a software program; and
a processor operatively coupled to the network transmitter, network receiver, and memory device, the processor being structured to execute the software program, the software program being structured to cause the processor to:
(i) process a plurality of exchanges of a plurality metals between a plurality of metal buyers and a plurality of metal sellers;
(ii) provide a weighted average price index based on the plurality of exchanges in compliance with FAS133 requirements for market-based pricing;
(iii) provide real time price adjustments online, the real time price adjustments being based on a chemical composition associated with a particular metal from the plurality metals; and
(iv) facilitate a purchase of a FAS133 compliant derivative contract online.

65. A metals exchange server as defined in claim 64, wherein the software program is further structured to cause the processor to transmit metal exchange transaction information to a plurality of registered users to provide price transparency, the metal exchange transaction information including a plurality of metal lot records, each metal lot record including a lot type, a lot quantity, a lot price, and an exchange date.

66. A metals exchange server as defined in claim 64, wherein the software program is further structured to cause the processor to transmit an offer to sell at least one of a metals hedging contract and a logistics contract.

67. A metals exchange server as defined in claim 64, wherein the software program is further structured to cause the processor to perform at lest one of a portfolio valuation and a mark to market determination.

68. A metals exchange server as defined in claim 64, wherein the software program is further structured to cause the processor to transmit at least one of a payment guarantee to the metal seller and a financing option to the metal buyer via the network transmitter.
